(19) United States
(12) Patent Application Publication
(10) Pub. No.: US 2022/0308484 A1
(43) Pub. Date: Sep. 29, 2022

(54) METHOD FOR PRODUCING TONER FOR DEVELOPING ELECTROSTATIC CHARGE IMAGE, AND TONER FOR DEVELOPING ELECTROSTATIC CHARGE IMAGE

(71) Applicant: FUJIFILM Business Innovation Corp., Tokyo (JP)

(72) Inventors: Ryutaro KEMBO, Kanagawa (JP); Yukiaki NAKAMURA, Kanagawa (JP); Masaru TAKAHASHI, Kanagawa (JP)

(73) Assignee: FUJIFILM Business Innovation Corp., Tokyo (JP)

(21) Appl. No.: 17/462,292

(22) Filed: Aug. 31, 2021

(30) Foreign Application Priority Data
Mar. 29, 2021 (JP) 2021-055130

(51) Int. Cl. G03G 9/08; G03G 9/12

(52) U.S. Cl. CPC G03G 9/0819; G03G 9/0823; G03G 9/12; B82Y 40/00

(57) ABSTRACT

A method for producing a toner for developing an electrostatic charge image includes: performing first aggregation that involves, in a dispersion containing first amorphous resin particles, aggregating at least the first amorphous resin particles; performing second aggregation that involves, in a dispersion that contains second amorphous resin particles and first aggregated particles obtained by aggregating the first amorphous resin particles, aggregating the second amorphous resin particles around the first aggregated particles; and heating a dispersion that contains second aggregated particles obtained by aggregating the second amorphous resin particles around the first aggregated particles so as to fuse and coalesce the second aggregated particles and form toner particles, in which a volume-average particle diameter DB of the second amorphous resin particles is smaller than a volume-average particle diameter DA of the first amorphous resin particles, and the first amorphous resin particles have a glass transition temperature of 50° C. or higher, and the second amorphous resin particles have a glass transition temperature of 50° C. or higher and 63° C. or lower.

### CROSS-REFERENCE TO RELATED APPLICATIONS

This application is based on and claims priority under 35 USC 119 from Japanese Patent Application No. 2021-055130 filed Mar. 29, 2021.

### BACKGROUND

### (i) Technical Field

The present disclosure relates to a method for producing a toner for developing an electrostatic charge image, and a toner for developing an electrostatic charge image.

### (ii) Related Art

For example, Japanese Unexamined Patent Application Publication No. 2007-3840 discloses a toner for developing an electrostatic charge image, the toner including a core particle containing a binder resin and a coloring agent, and a shell layer covering the core particle, in which the binder resin contains at least one selected from crystalline polyester resins and amorphous resins, the shell layer contains amorphous resin fine particles, the amorphous resin fine particles have a volume-average particle diameter of 20 to 800 nm and a glass transition temperature of 65° C. or higher, and the amorphous resin fine particle content relative to the weight of the core particle is in the range of 5 to 25 wt %.

Japanese Unexamined Patent Application Publication No. 2014-2310 discloses a method for producing a toner for developing an electrostatic charge image, the toner including a core-shell structure toner particle in which a shell layer formed of a shell resin containing a polyester resin is formed on a surface of a core particle containing a resin, the method including: a phase inversion emulsification step of adding a water-based medium to a shell resin solution prepared by dissolving the shell resin in a hydrophilic organic solvent so as to obtain an emulsion in which oil droplets formed of the shell resin solution are dispersed in the water-based medium, and then removing the organic solvent from the oil droplets to obtain shell resin fine particles; and a shell layer forming step of adding, to a water-based medium containing dispersed core particles, the shell resin fine particles obtained in the phase inversion emulsification step so as to aggregate and fusion-bond the shell resin fine particles on the surface of the core particle. Here, the shell resin has an acid value of 15 to 30 mgKOH/g, the organic solvent is removed in the phase inversion emulsification step at a temperature equal to or higher than the glass transition temperature of the shell resin but not higher than a temperature 30° C. higher than the glass transition temperature of the shell resin, and the shell resin fine particles have a particle size distribution (CV value) of 10 to 35%.

Japanese Unexamined Patent Application Publication No. 2008-65180 discloses a method for producing functional particles, the method including passing a mixed slurry, which contains core particles formed of resin particles and shell particles formed of inorganic particles or resin particles having a smaller volume-average particle diameter than the core particles, through a coil-shaped pipe while heating the mixed slurry to a temperature equal to or higher than the glass transition temperature of the core particles so as to obtain functional particles in which shell resin particles are attached to the core particle surfaces.

### SUMMARY

Aspects of non-limiting embodiments of the present disclosure relate to a method for producing a toner for developing an electrostatic charge image, the toner having a narrow particle size distribution compared to a method that includes performing first aggregation that involves, in a dispersion containing first amorphous resin particles, aggregating at least the first amorphous resin particles; performing second aggregation that involves, in a dispersion that contains second amorphous resin particles and first aggregated particles obtained by aggregating the first amorphous resin particles, aggregating the second amorphous resin particles around the first aggregated particles; and heating a dispersion that contains second aggregated particles obtained by aggregating the second amorphous resin particles around the first aggregated particles so as to fuse and coalesce the second aggregated particles and form toner particles, in which the volume-average particle diameter DB of the second amorphous resin particles is larger than the volume-average particle diameter DA of the first amorphous resin particles, the glass transition temperatures of the first amorphous resin particles and the second amorphous resin particles are lower than 50° C., or the glass transition temperature of the second amorphous resin particles is higher than 63° C.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a method for producing a toner for developing an electrostatic charge image, the method including: performing first aggregation that involves, in a dispersion containing first amorphous resin particles, aggregating at least the first amorphous resin particles; performing second aggregation that involves, in a dispersion that contains second amorphous resin particles and first aggregated particles obtained by aggregating the first amorphous resin particles, aggregating the second amorphous resin particles around the first aggregated particles; and heating a dispersion that contains second aggregated particles obtained by aggregating the second amorphous resin particles around the first aggregated particles so as to fuse and coalesce the second aggregated particles and form toner particles, in which a volume-average particle diameter DB of the second amorphous resin particles is smaller than a volume-average particle diameter DA of the first amorphous resin particles, and the first amorphous resin particles have a glass transition temperature of 50° C. or higher, and the second amorphous resin particles have a glass transition temperature of 50° C. or higher and 63° C. or lower.

### BRIEF DESCRIPTION OF THE DRAWINGS

Exemplary embodiments of the present disclosure will be described in detail based on the following figures, wherein:

FIG. 1 is a schematic diagram illustrating one example of an image forming apparatus according to an exemplary embodiment; and

FIG. 2 is a schematic diagram illustrating one example of a process cartridge according to an exemplary embodiment.

### DETAILED DESCRIPTION

Hereinafter, exemplary embodiments, which are some examples of the present disclosure, are described. The following descriptions and the examples are merely exemplary and do not limit the present disclosure.

In this description, a numerical range that uses “to” refers to a range that includes a figure that precedes “to” and a figure that follows “to” as the minimum value and the maximum value, respectively.

In numerical ranges described stepwise in the present description, the upper limit or the lower limit of one numerical range may be substituted with an upper limit or a lower limit of a different numerical range also described stepwise. In any numerical range described in the present description, the upper limit or the lower limit of the numerical range may be substituted with a value indicated in Examples.

In this description, the term “step” refers not only to an independent step but also to any feature that attains the intended purpose of that step even if this feature is not clearly distinguishable from other steps.

In this description, when a drawing is referred to describe an exemplary embodiment, the structure of that exemplary embodiment is not limited to the structure illustrated in the drawing. Moreover, the size of a member in each drawing is schematic, and the relative size relationship between the members is not limited to what is illustrated.

In this description, each component may contain two or more corresponding substances. In this disclosure, when the amount of a component in the composition is described and when there are two or more substances that correspond to that component in the composition, the amount of that component is the total amount of the two or more substances present in the composition unless otherwise noted.

In this description, the “toner for developing an electrostatic charge image” may be simply referred to as the “toner”.

### Method for Producing Toner for Developing Electrostatic Charge Image

A method for producing the toner according to an exemplary embodiment includes a first aggregation step that involves aggregating at least first amorphous resin particles, in a dispersion containing first amorphous resin particles, aggregating at least the first amorphous resin particles; a second aggregation step that involves, in a dispersion that contains second amorphous resin particles and first aggregated particles obtained by aggregating the first amorphous resin particles, aggregating the second amorphous resin particles around the first aggregated particles; and a fusing and coalescing step that involves heating a dispersion that contains second aggregated particles obtained by aggregating the second amorphous resin particles around the first aggregated particles so as to fuse and coalesce the second aggregated particles and form toner particles. The volume-average particle diameter DB of the second amorphous resin particles is smaller than the volume-average particle diameter DA of the first amorphous resin particles. In addition, the first amorphous resin particles have a glass transition temperature of 50° C. or higher, and the second amorphous resin particles have a glass transition temperature of 50° C. or higher and 63° C. or lower.

Here, the toner particles obtained by the toner production method according to this exemplary embodiment each have a core portion (hereinafter may also be referred to as a core) and a coating layer (hereinafter may also be referred to as a shell layer) covering the core portion (these toner particles may also be referred to as core/shell toner particles).

The core portion corresponds to an area where the first aggregated particles formed by aggregation of the first amorphous resin particles have fused and coalesced, and the coating layer corresponds to the area where the second amorphous resin particles that have aggregated around the first aggregated particles have fused and coalesced.

With the toner production method according to this exemplary embodiment, a toner having narrow a particle size distribution is obtained. The reason for this is presumably as follows.

There is known a method for producing toner particles by an emulsification aggregation method.

However, the current trends expect delicate structural control on the toner particles. Thus, particle forming stability of the toner particles is to be further improved also in the emulsification aggregation method.

In particular, when producing core/shell toner particles by the emulsification aggregation method, improved particle forming stability and a narrower particle size distribution are expected. This is because the particle size distribution of the toner particles affects the chargeability of the toner, and further narrowing the particle size distribution of the toner particles improves image quality and product quality.

Thus, in the toner production method of this exemplary embodiment, the volume-average particle diameter DB of the second amorphous resin particles for forming the shell layer is set to be smaller than the volume-average particle diameter DA of the first amorphous resin particles for forming the core.

In this manner, the second amorphous resin particles, which have a larger specific surface area, in other words, larger surface energy, are more likely to melt before the first amorphous resin particles. In addition, the increase in contact area where the second amorphous resin particles contact the first aggregated particles (in other words, the core after the fusing and coalescing) increases the aggregation force of the second amorphous resin particles. It is considered that, as a result, in the process from the second aggregation step to the fusing and coalescing step, the materials that are unstable in controlling the aggregation and contained in the core are inhibited from becoming exposed at the outermost surface (in other words, the outside of the second amorphous resin particles that constitute the shell layer) of the aggregates, and the particle forming property is stabilized.

As a result, the particle size distribution of the toner particles becomes narrow.

Furthermore, the first amorphous resin particles have a glass transition temperature of 50° C. or higher, and the second amorphous resin particles have a glass transition temperature of 50° C. or higher and 63° C. or lower.

When the glass transition temperature of the second amorphous resin particle is 50° C. or higher and 63° C. or lower and the volume-average particle diameter DB of the second amorphous resin particles is smaller than the volume-average particle diameter DA of the first amorphous resin particles, the second amorphous resin particles are more likely to melt before the materials constituting the core included in the first aggregates of the first amorphous resin particles in the first aggregation step. It is considered that, as a result, in the process from the second aggregation step to the fusing and coalescing step, the materials that are unstable in controlling the aggregation and contained in the core are inhibited from becoming exposed at the shell layer surface, and thereby the particle forming property is stabilized.

Thus, the particle size distribution of the toner particles becomes narrow.

In the ranges where the glass transition temperature of the first amorphous resin particles is lower than 50° C. or the glass transition temperature of the second amorphous resin particles is higher than 63° C., the particle size distribution is degraded if the difference between the volume-average particle diameter DA of the first amorphous resin particles and the volume-average particle diameter DB of the second amorphous resin particles is small. This is presumably because the first amorphous resin particles constituting the core are more likely to melt before the second amorphous resin particles constituting the shell layer, and thus, in the process from the second aggregation step to the fusing and coalescing step, the materials that are unstable in controlling the aggregation and contained in the core become exposed at the shell layer surface, and some of the particles re-aggregate and coarsen during these steps, thereby degrading the particle forming property. If the glass transition temperature of the second amorphous resin particles is lower than 50° C., the particle size distribution is degraded in the external addition step. This is presumably due to the re-aggregation and coarsening of the toner particles due to the heat applied during the external addition.

It is inferred from the aforementioned descriptions that a toner having a narrow particle size distribution is obtained by the toner production method according to this exemplary embodiment.

In the toner production method of the exemplary embodiment, the glass transition temperature Tg of the first amorphous resin particles is 50° C. or higher, and the glass transition temperature of the second amorphous resin particles is 50° C. or higher and 63° C. or lower; however, from the viewpoint of narrowing the particle size distribution of the toner particles, the glass transition temperature of the first amorphous resin particles can be 50° C. or higher, and the glass transition temperature of the second amorphous resin particles can be 50° C. or higher and 60° C. or lower. From the viewpoint of low-temperature fixability, the glass transition temperature of the first amorphous resin particles may be 63° C. or lower.

The glass transition temperature of the resin particles is determined from a DSC curve obtained by differential scanning calorimetry (DSC), more specifically, according to “extrapolated glass transition onset temperature” described in the method for determining the glass transition temperature in JIS K 7121:1987 “Testing Methods for Transition Temperatures of Plastics”.

The difference (DA−DB) between the volume-average particle diameter DA of the first amorphous resin particles and the volume-average particle diameter DB of the second amorphous resin particles is preferably 20 nm or more, more preferably 30 nm or more, and yet more preferably 45 nm or more from the viewpoint of narrowing the particle size distribution of the toner particles.

However, the difference (DA−DB) is preferably 300 nm or less and more preferably 270 nm or less from the viewpoint of manufacturability (in other words, the controllability of the toner particle diameter and the particle size distribution).

From the viewpoint of narrowing the particle size distribution of the toner particles, the volume-average particle diameter DA of the first amorphous resin particles is preferably 100 nm or more and 300 nm or less, more preferably 120 nm or more and 280 nm or less, and yet more preferably 140 nm or more and 260 nm or less.

Here, the first amorphous resin particles may contain two or more amorphous resin particles having different volume-average particle diameters.

However, as the first amorphous resin particles, although the two or more amorphous resin particles may have volume-average particle diameters that are outside the range of the volume-average particle diameter DA of the first amorphous resin particles, the volume-average particle diameter of the mixed particles obtained by mixing the two or more amorphous resin particles having different volume-average particle diameters is preferably within the range of the volume-average particle diameter DA of the first amorphous resin particles from the viewpoint of narrowing the particle size distribution of the toner particles.

From the viewpoint of narrowing the particle size distribution of the toner particles, the volume-average particle diameter DB of the second amorphous resin particles is preferably 20 nm or more and 170 nm or less, more preferably 40 nm or more and 150 nm or less, and yet more preferably 50 nm or more and 130 nm or less.

Here, the second amorphous resin particles may contain two or more amorphous resin particles having different volume-average particle diameters.

However, as the second amorphous resin particles, although the two or more amorphous resin particles may have volume-average particle diameters that are outside the range of the volume-average particle diameter DB of the second amorphous resin particles, the volume-average particle diameter of the mixed particles obtained by mixing the two or more amorphous resin particles having different volume-average average particle diameters is preferably within the range of the volume-average particle diameter DB of the second amorphous resin particles from the viewpoint of narrowing the particle size distribution of the toner particles.

The same applies to the number particle diameter D16p of the second amorphous resin particles and the proportion of the particles having a particle diameter of 100 nm or less.

From the viewpoint of narrowing the particle size distribution of the toner particles, the number particle diameter D16p of the second amorphous resin particles is preferably 5 nm or more and 140 nm or less and more preferably 10 nm or more and 100 nm or less.

In the particle size distribution of the second amorphous resin particles, particles having a particle diameter of 100 nm or less preferably account for 10 vol % or more and 100 vol % or less, more preferably 15 vol % or more and 100 vol % or less, and yet more preferably 20 vol % or more and 100 vol % or less.

When the proportion of the particles having a particle diameter of 100 nm or less in the particle size distribution of the second amorphous resin particles is in the aforementioned range, the ratio of the fine particles increases, and thus the second amorphous resin particles, which have a larger specific surface area, in other words, larger surface energy, are more likely to melt before the first amorphous resin particles. In addition, the increase in contact area where the second amorphous resin particles contact the first aggregated particles (in other words, the core after the fusing and coalescing) increases the aggregation force of the second amorphous resin particles. It is considered that, as a result, in the process from the second aggregation step to the fusing and coalescing step, the materials that are unstable in controlling the aggregation and contained in the core are inhibited from becoming exposed at the outermost surface (the outside of the second amorphous resin particles that constitute the shell layer) of the aggregates, thereby stabilizing the particle forming property.

Thus, the particle size distribution of the toner particles becomes narrower.

Here, the methods for measuring the particle size distribution and the particle diameter of the resin particles are as follows.

The particle size distribution is obtained by measurement using a laser diffraction particle size distribution meter (for example, LA-700 produced by Horiba Ltd.). Cumulative distributions of the volume and number are each plotted from the small diameter size relative to the particle size ranges (channels) split on the basis of the particle size distribution to be measured, and the particle diameter at 16% accumulation is defined as a volume particle diameter D16v and a number particle diameter D16p, the particle diameter at 50% accumulation is defined as a volume-average particle diameter D50v and a number average particle diameter D50p, and the particle diameter at 84% accumulation is defined as a volume particle diameter D84v and a number particle diameter D84p.

From these values, the volume particle size distribution index (GSDv) is calculated as (D84v/D16v)^{1/2} and the number particle size distribution index (GSDp) is calculated as (D84p/D16p)^{1/2}.

In addition, the proportion of particles having a particle diameter of 100 nm or less is determined by accumulating the frequency of particles counted in the particle size range (channel) of 0 to 100 nm among the particles measured and detected.

In the toner production method according to the exemplary embodiment, the second aggregation step may be performed multiple times. When the second aggregation step is performed multiple times, at least one of the multiple times of performing the second aggregation step other than the one performed last may be a step of aggregating, in a dispersion, the second amorphous resin particles and releasing agent particles around the first aggregated particles, the dispersion containing the first aggregated particles, the second amorphous resin particles, and the releasing agent particles.

As higher image quality is pursued, delicate toner structure control is expected in order to place the materials constituting the toner particles to the positions suitable for exhibiting their functions. It is known that when the releasing agent, which has a function of releasing from a fixing member, is placed on the toner surface, the releasing agent effectively exhibits the releasing function.

However, placing the releasing agent on the toner surface side (that is, incorporating the releasing agent in the shell layer) may result in exposure of the releasing agent on the toner particle surfaces. Since the releasing agent is substantially free of functional groups, the releasing agent particles in the dispersion are unstable. Thus, in the emulsification aggregation method, during the process of elevating the temperature to the fusing and coalescing temperature of the aggregated particles, the releasing agent may emerge and leak onto the surfaces of the aggregated particles, the repulsion force between the aggregated particles may decrease, and two or more aggregated particles may aggregate again, thereby possibly widening the particle size distribution of the obtained toner particles.

In contrast, according to the toner production method of this exemplary embodiment, a toner having a narrow particle size distribution is obtained even when releasing agent particles are used together with the second amorphous resin particles that form the shell layer. The reason for this is presumably as follows.

First, it is considered that, since the volume-average particle diameter DB of the second amorphous resin particles for forming the shell layer is smaller than the volume-average average particle diameter DA of the first amorphous resin particles for forming the core, the second amorphous resin particles, which have a large specific surface area, in other words, larger surface energy, are more likely flow relatively before the first amorphous resin particles. As a result, during the process of elevating the temperature to the fusing and coalescing temperature of the aggregated particles, the releasing agent is inhibited from coming out on the surfaces of the aggregated particles.

In addition, the smaller the diameter of the second amorphous resin particles, the less likely that the releasing agent particles come out on the surface of the aggregated particles. This is presumably due to the increase in the contact area between the surfaces of the first aggregated particles (in other words, the core particles) and the second amorphous resin particles.

Thus, it is assumed that, according to the toner production method of this exemplary embodiment, a toner having a narrow particle size distribution is obtained even when releasing agent particles are used together with the second amorphous resin particles that form the shell layer.

In the toner production method of this exemplary embodiment, the exposure ratio of the releasing agent on the surfaces of the obtained toner particles is preferably 25% or less and more preferably 15% or less from the viewpoint of narrowing the particle size distribution. Ideally, the exposure ratio of the releasing agent is 0%.

The method for measuring the exposure ratio of the releasing agent on the toner particle surfaces is as follows.

The exposure ratio of the releasing agent is measured by using toner particles as a measurement sample and by X-ray photoelectron spectroscopy (XPS). The XPS meter used is JPS-9000MX produced by JEOL Ltd. In the measurement, MgK α radiation is used as the X-ray source, the acceleration voltage is set to 10 kV, and the emission current is set to 30 mA. Here, the amounts of the binder resin and the releasing agent on the surfaces of the toner particles are determined by a C1s spectrum peak resolving method. The peak resolving method involves splitting the measured C1s spectrum into respective components by curve fitting through a least squares method. The component spectra used as the base for resolving are C1s spectra obtained by independently measuring the releasing agent and the binder resin used in preparation of the toner particles.

Then the ratio of the C1ₛ spectrum intensity derived from the releasing agent on the surfaces of the toner particles relative to the total C1ₛ spectrum intensity derived from the binder resin and the releasing agent on the surfaces of the toner particles is calculated as the exposure ratio (%) of the releasing agent on the surfaces of the toner particles.

Hereinafter, the toner production method according to an exemplary embodiment is described in detail.

In the toner production method of the exemplary embodiment, toner particles are produced through a first aggregation step, a fusing and coalescing step, and a second aggregation step. The toner production method according to this exemplary embodiment may involve externally adding an external additive to the toner particles after the production of the toner particles.

Hereinafter, the respective steps are described in detail.

Although a method for obtaining toner particles containing an amorphous resin and a crystalline resin that serve as binder resins, a coloring agent, and a releasing agent is described below, the crystalline resin, the coloring agent, and the releasing agent are optional. It is needless to say that any additives other than the coloring agent and the releasing agent may also be used.

### Dispersion Preparation Step

First, processes of preparing various dispersions are described.

First, resin particle dispersions respectively containing dispersed resin particles that serve as binder resins (an amorphous resin particle dispersion and a crystalline resin particle dispersion), and, for example, a coloring agent particle dispersion containing dispersed coloring agent particles and a releasing agent particle dispersion containing dispersed releasing agent particles are prepared.

### Resin Particle Dispersions

A resin particle dispersion is prepared by, for example, dispersing resin particles in a dispersion medium by using a surfactant.

Amorphous resin particles and crystalline resin particles are used as the resin particles.

However, when amorphous resin particles and crystalline resin particles are used together, the mass ratio of the crystalline resin to the amorphous resin in the toner particles (crystalline resin/amorphous resin) is preferably 3/97 or more and 50/50 or less and more preferably 7/93 or more and 30/70 or less.

Here, an amorphous resin refers to a resin that exhibits only a stepwise endothermic change rather than a clear endothermic peak in thermal analysis by differential scanning calorimetry (DSC), that is solid at room temperature, and that turns thermoplastic at a temperature equal to or higher than the glass transition temperature.

In contrast, a crystalline resin refers to a resin that has a clear endothermic peak rather than a stepwise endothermic change in differential scanning calorimetry (DSC).

Specifically, for example, a crystalline resin refers to a resin that has an endothermic peak having a half width of 10° C. or less when measured at a heating rate of 10° C./min, and an amorphous resin refers to a resin that has a half width exceeding 10° C. or has no clear endothermic peak.

The amorphous resin that constitutes the amorphous resin particles will now be described.

Examples of the amorphous resin include known amorphous resins such as amorphous polyester resins, amorphous vinyl resins (for example, styrene acrylic resin), epoxy resins, polycarbonate resins, and polyurethane resins. Among these, amorphous polyester resins and amorphous vinyl resins (in particular, styrene acrylic resins) are preferable, and amorphous polyester resins are more preferable.

An amorphous polyester resin and a styrene acrylic resin can be used in combination as the amorphous resin. Alternatively, an amorphous resin that has an amorphous polyester resin segment and a styrene acrylic resin segment can be used as the amorphous resin.

In particular, when an amorphous resin that has an amorphous polyester resin segment and a styrene acrylic resin segment is used and when these resins are bonded through an ester bond, the amorphous resin becomes readily compatible with an ester releasing agent, and thus, the toner fusibility is improved. As a result, image omission is further suppressed even when an image having a large toner coating amount is formed at high speed on a recording medium having irregularities.

### Amorphous Polyester Resin

Examples of the amorphous polyester resins include polycondensation products between polycarboxylic acids and polyhydric alcohols. A commercially available amorphous polyester resin or a synthesized amorphous polyester resin may be used as the amorphous polyester resin.

Examples of the polycarboxylic acids include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, and lower (for example, 1 to 5 carbon atoms) alkyl esters thereof. Among these, aromatic dicarboxylic acids can be used as polycarboxylic acids.

A dicarboxylic acid and a tri- or higher carboxylic acid having a crosslinked structure or a branched structure may be used in combination as the polycarboxylic acid. Examples of the tri- or higher carboxylic acid include trimellitic acid, pyromellitic acid, anhydrides thereof, and lower (for example, 1 to 5 carbon atoms) alkyl esters thereof.

These polycarboxylic acids may be used alone or in combination.

Examples of the polyhydric alcohols include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adducts of bisphenol A and propylene oxide adducts of bisphenol A). Among these, aromatic diols and alicyclic diols are preferred, and aromatic diols are more preferred as the polyhydric alcohols.

A trihydric or higher alcohol having a crosslinked structure or a branched structure may be used in combination with a diol as the polyhydric alcohol. Examples of the trihydric or higher alcohol include glycerin, trimethylolpropane, and pentaerythritol.

These polyhydric alcohols may be used alone or in combination.

The amorphous polyester resin is obtained by a known production method. Specifically, the amorphous polyester resin is obtained by a method that involves, for example, setting the polymerization temperature to 180° C. or higher and 230° C. or lower, depressurizing the inside of the reaction system as necessary, and performing reaction while removing water and alcohol generated during the condensation. When the monomers of the raw materials do not dissolve or mix at the reaction temperature, a high-boiling-point solvent may be added as a dissolving aid. In such a case, the polycondensation reaction is performed while distilling away the dissolving aid. In the copolymerization reaction, when a poorly compatible monomer is present, that monomer may be subjected to condensation with an acid or alcohol for the condensation in advance, and then subjected to polycondensation with other component.

Examples of the amorphous polyester resin include unmodified amorphous polyester resins and modified amorphous polyester resins. A modified amorphous polyester resin is an amorphous polyester resin in which a bonding group other than the ester bond is present or an amorphous polyester resin in which a resin component different from polyester is bonded through a covalent bond, an ionic bond, or the like. Examples of the modified amorphous polyester resin include resins having modified terminals obtained by reacting an active hydrogen compound with an amorphous polyester resin having a functional group, such as an isocyanate group, introduced into the terminal thereof.

The amorphous polyester resin preferably accounts for 60 mass % or more and 98 mass % or less, more preferably 65 mass % or more and 95 mass % or less, and yet more preferably 70 mass % or more and 90 mass % or less of the entire binder resin.

### Styrene Acrylic Resin

A styrene acrylic resin is a copolymer obtained by copolymerizing at least a styrene monomer (a monomer having a styrene skeleton) and a (meth)acryl monomer (a monomer having a (meth)acryl group, preferably, a monomer having a (meth)acryloxy group). The styrene acrylic resin includes, for example, a copolymer of a styrene monomer and a (meth)acrylate monomer.

The acrylic resin moiety in the styrene acrylic resin is a partial structure obtained by polymerizing one or both of an acryl monomer and a methacrylic monomer. The term “(meth)acryl” includes both acryl and methacryl.

Examples of the styrene monomer include styrene, α-methylstyrene, metachlorostyrene, parachlorostyrene, parafluorostyrene, paramethoxystyrene, meta-tert-butoxystyrene, para-tert-butoxystyrene, paravinylbenzoic acid, and paramethyl-α-methylstyrene. These styrene monomers may be used alone or in combination.

Examples of the (meth)acryl monomer include (meth)acrylic acid, methyl (meth)acrylate, ethyl (meth)acrylate, n-propyl (meth)acrylate, isopropyl (meth)acrylate, n-butyl (meth)acrylate, isobutyl (meth) acrylate, n-hexyl (meth) acrylate, 2-ethylhexyl (meth)acrylate, lauryl (meth)acrylate, stearyl (meth) acrylate, cyclohexyl (meth) acrylate, dicyclopentanyl (meth) acrylate, isobornyl (meth) acrylate, 2-hydroxyethyl (meth)acrylate, hydroxypropyl (meth)acrylate, and 4-hydroxybutyl (meth)acrylate. These (meth)acrylic acid monomers may be used alone or in combination.

The polymerization ratio of the styrene monomer to the (meth)acryl monomer on a mass basis can be styrene monomer: (meth)acryl monomer=70:30 to 95:5.

The styrene acrylic resin may have a crosslinked structure. The styrene acrylic resin having a crosslinked structure can be produced by, for example, copolymerizing a styrene monomer and a (meth)acryl monomer. The crosslinking monomer is not particularly limited and can be a difunctional or higher (meth)acrylate compound.

The method for preparing the styrene acrylic resin is not particularly limited, and, for example, solution polymerization, precipitation polymerization, suspension polymerization, bulk polymerization, or emulsification polymerization is applied. A known process (for example, batch, semi-continuous, or continuous method) is applied to the polymerization reaction.

The styrene acrylic resin preferably accounts for 0 mass % or more and 20 mass % or less, more preferably 1 mass % or more and 15 mass % or less, and yet more preferably 2 mass % or more and 10 mass % or less of the entire binder resin.

### An Amorphous Resin Having an Amorphous Polyester Resin Segment and a Styrene Acrylic Resin Segment (Hereinafter, May Also be Referred to as a “Hybrid Amorphous Resin”)

A hybrid amorphous resin is an amorphous resin in which an amorphous polyester resin segment and a styrene acrylic resin segment are chemically bonded.

Examples of the hybrid amorphous resin include a resin that has a polyester resin main chain and a styrene acrylic resin side chain chemically bonded to the main chain; a resin that has a styrene acrylic resin main chain and a polyester resin side chain chemically bonded to the main chain; a resin that has a main chain formed of a polyester resin and a styrene acrylic resin chemically bonded to each other; and a resin that has a main chain formed of a polyester resin and a styrene acrylic resin chemically bonded to each other, and at least one side chain selected from a polyester resin side chain chemically bonded to the main chain and a styrene acrylic resin side chain chemically bonded to the main chain.

The amorphous polyester resin and the styrene acrylic resin constituting the segments are as described above, and the descriptions therefor are omitted.

The total amount of the polyester resin segment and the styrene acrylic resin segment in the entire hybrid amorphous resin is preferably 80 mass % or more, more preferably 90 mass % or more, yet more preferably 95% mass % or more, and still more preferably 100 mass %.

The ratio of the styrene acrylic resin segment relative to the total amount of the polyester resin segment and the styrene acrylic resin segment in the hybrid amorphous resin is preferably 20 mass % or more and 60 mass % or less, more preferably 25 mass % or more and 55 mass % or less, and yet more preferably 30 mass % or more and 50 mass % or less.

The hybrid amorphous resin can be produced by any one of the following methods (i) to (iii).

(i) After preparing a polyester resin segment by condensation polymerization between a polyhydric alcohol and a polycarboxylic acid, a monomer constituting a styrene acrylic resin segment is addition-polymerized with the polyester resin segment.
(ii) After a styrene acrylic resin segment is prepared by addition polymerization of an addition polymerizable monomer, a polyhydric alcohol and a polycarboxylic acid are condensation-polymerized.
(iii) Condensation polymerization between a polyhydric alcohol and a polycarboxylic acid and addition polymerization of an addition polymerizable monomer are performed concurrently.

The hybrid amorphous resin preferably accounts for 60 mass % or more and 98 mass % or less, more preferably 65 mass % or more and 95 mass % or less, and yet more preferably 70 mass % or more and 90 mass % or less of the entire binder resin.

The properties of the amorphous resin will now be described.

The weight average molecular weight (Mw) of the amorphous resin is preferably 5000 or more and 1000000 or less and more preferably 7000 or more and 500000 or less.

The number average molecular weight (Mn) of the amorphous resin can be 2000 or more and 100000 or less.

The molecular weight distribution Mw/Mn of the amorphous resin is preferably 1.5 or more and 100 or less and more preferably 2 or more and 60 or less.

The weight average molecular weight and the number average molecular weight are measured by gel permeation chromatography (GPC). The molecular weight measurement by GPC is conducted by using GPC·HLC-8120GPC produced by TOSOH CORPORATION as a measuring instrument with columns, TSKgel Super HM-M (15 cm) produced by TOSOH CORPORATION, and a THF solvent. The weight average molecular weight and the number average molecular weight are calculated from the measurement results by using the molecular weight calibration curves obtained from monodisperse polystyrene standard samples.

The crystalline resin that constitutes the crystalline resin particles will now be described.

Examples of the crystalline resin include known crystalline resins such as a crystalline polyester resin and a crystalline vinyl resin (for example, a polyalkylene resin and a long chain alkyl (meth)acrylate resin). Among these, from the viewpoints of the mechanical strength and low-temperature fixability of the toner, a crystalline polyester resin can be used.

### Crystalline Polyester Resin

Examples of the crystalline polyester resin include polycondensation products between polycarboxylic acids and polyhydric alcohols. A commercially available crystalline polyester resin or a synthesized crystalline polyester resin may be used as the crystalline polyester resin.

To smoothly form a crystal structure, the crystalline polyester resin can be a polycondensation product obtained by using a linear aliphatic polymerizable monomer rather than a polymerizable monomer having an aromatic ring.

Examples of the polycarboxylic acids include aliphatic dicarboxylic acids (for example, oxalic acid, succinic acid, glutaric acid, adipic acid, suberic acid, azelaic acid, sebacic acid, 1,9-nonandicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, and lower (for example, 1 to 5 carbon atoms) alkyl esters thereof.

A dicarboxylic acid and a tri- or higher carboxylic acid having a crosslinked structure or a branched structure may be used in combination as the polycarboxylic acid. Examples of the tricarboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides thereof, and lower (for example, 1 to 5 carbon atoms) alkyl esters thereof.

Together with these dicarboxylic acids, a dicarboxylic acid having a sulfonic acid group and a dicarboxylic acid having an ethylenic double bond may be used in combination.

These polycarboxylic acids may be used alone or in combination.

Examples of the polyhydric alcohol include aliphatic diols (for example, linear aliphatic diols having a main chain moiety having 7 to 20 carbon atoms). Examples of the aliphatic diol include ethylene glycol, 1, 3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these, 1,8-octanediol, 1,9-nonanediol, and 1,10-decanediol are preferable as the aliphatic diol.

A trihydric or higher alcohol having a crosslinked structure or a branched structure may be used in combination with a diol in the polyhydric alcohol. Examples of the trihydric or higher alcohol include glycerin, trimethylolethane, trimethylolpropane, and pentaerythritol.

These polyhydric alcohols may be used alone or in combination.

The polyhydric alcohol preferably contains 80 mol % or more and more preferably 90 mol % or more of the aliphatic diol.

As with the amorphous polyester resin, the crystalline polyester resin is obtained by a known production method.

The crystalline polyester resin can be a polymer formed between α,ω-linear aliphatic dicarboxylic acid and α,ω-linear aliphatic diol.

As α,ω-linear aliphatic dicarboxylic acid, α,ω-linear aliphatic dicarboxylic acid in which the alkylene group linking the two carboxy groups has 3 to 14 carbon atoms is preferable, and the alkylene group more preferably has 4 to 12 carbon atoms, and yet more preferably has 6 to 10 carbon atoms.

Examples of α,ω-linear aliphatic dicarboxylic acid include succinic acid, glutaric acid, adipic acid, 1,6-hexanedicarboxylic acid (also known as suberic acid), 1,7-heptanedicarboxylic acid (also known as azelaic acid), 1,8-octanedicarboxylic acid (also known as sebacic acid), 1,9-nonandicarboxylic acid, 1,10-decanedicarboxylic acid, 1,2-dodecanedicarboxylic acid, 1,14-tetradecanedicarboxylic acid, and 1,18-octadecanedicarboxylic acid. Among these, 1,6-hexanedicarboxylic acid, 1,7-heptanedicarboxylic acid, 1,8-octanedicarboxylic acid, 1,9-nonanedicarboxylic acid, and 1,10-decanedicarboxylic acid are preferable.

These α,ω-linear aliphatic dicarboxylic acids may be used alone or in combination.

As α,ω-linear aliphatic diol, α,ω-linear aliphatic diol in which the alkylene group linking the two hydroxy groups has 3 to 14 carbon atoms is preferable, and the alkylene group more preferably has 4 to 12 carbon atoms, and yet more preferably has 6 to 10 carbon atoms.

Examples of the α,ω-linear aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, and 1,18-octadecanediol, and, among these, 1,6-hexanediol, 1,7-heptanediol, 1,8-octanediol, 1,9-nonanediol, and 1,10-decanediol are preferable.

These α,ω-linear aliphatic diols may be used alone or in combination.

From the viewpoint of suppressing image omission, the polymer formed between α,ω-linear aliphatic dicarboxylic acid and α,ω-linear aliphatic diol is preferably a polymer formed between at least one selected from the group consisting of 1,6-hexanedicarboxylic acid, 1,7-heptanedicarboxylic acid, 1,8-octanedicarboxylic acid, 1,9-nonanedicarboxylic acid, and 1,10-decanedicarboxylic acid and at least one selected from the group consisting of 1,6-hexanediol, 1,7-heptanediol, 1,8-octanediol, 1,9-nonanediol, and 1,10-decanediol, and is more preferably a polymer formed between 1,10-decanedicarboxylic acid and 1,6-hexanediol.

The crystalline polyester resin preferably accounts for 1 mass % or more and 20 mass % or less, more preferably 2 mass % or more and 15 mass % or less, and yet more preferably 3 mass % or more and 10 mass % or less of the entire binder resin.

The properties of the crystalline resin will now be described.

The melting temperature of the crystalline resin is preferably 50° C. or higher and 100° C. or lower, more preferably 55° C. or higher and 90° C. or lower, and yet more preferably 60° C. or higher and 85° C. or lower.

The melting temperature is determined from a DSC curve obtained by differential scanning calorimetry (DSC) by the method described in “Melting peak temperature”, which is one method for determining the melting temperature in JIS K 7121-1987 “Testing Methods for Transition Temperatures of Plastics”.

The weight average molecular weight (Mw) of the crystalline resin can be 6,000 or more and 35,000 or less.

Examples of the dispersion medium used in the resin particle dispersion include water-based media.

Examples of the water-based media include water such as distilled water and ion exchange water, and alcohols. These may be used alone or in combination.

Examples of the surfactant include anionic surfactants such as sulfate surfactants, sulfonate surfactants, phosphate surfactants, and soap surfactants; cationic surfactants such as amine salt surfactants and quaternary ammonium salt surfactants; and nonionic surfactants such as polyethylene glycol surfactants, alkyl phenol ethylene oxide adduct surfactants, and polyhydric alcohol surfactants. Among these, an anionic surfactant and a cationic surfactant are preferable. A nonionic surfactant may be used in combination with an anionic surfactant or a cationic surfactant.

These surfactants may be used alone or in combination.

Examples of the method for dispersing resin particles in a dispersion medium in preparing the resin particle dispersion include typical dispersing methods that use a rotary shear homogenizer, a ball mill having media, a sand mill, a dyno mill, etc. Depending on the type of the resin particles, the resin particles may be dispersed in a resin particle dispersion by a phase inversion emulsification method.

Here, the phase inversion emulsification method is a method that involves dissolving a resin to be dispersed in a hydrophobic organic solvent that can dissolve the resin, adding a base to the organic continuous phase (O phase) to neutralize, and adding a water medium (W phase) to the resulting product to perform W/O-to-O/W resin conversion (what is known as phase inversion) to form a discontinuous phase and disperse the particles of the resin in a water medium.

The amount of the resin particles contained in the resin particle dispersion is, for example, preferably 5 mass % or more and 50 mass % or less and more preferably 10 mass % or more and 40 mass % or less.

### Coloring Agent Particle Dispersion

The coloring agent particle dispersion is a dispersion obtained by dispersing at least a coloring agent in a water medium.

Examples of the coloring agent include various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These coloring agents may be used alone or in combination.

The coloring agent is dispersed in a water medium by a known method, and, for example, medium dispersers such as a rotary shear homogenizer, a ball mill, a sand mill, and an attritor, and a high-pressure collision dispersers can be used. Alternatively, the coloring agent may be dispersed in a water medium by using a polar ionic surfactant and a homogenizer to prepare a coloring agent particle dispersion.

The volume-average particle diameter of the coloring agent is preferably 1 μm or less, more preferably 0.5 μm or less, and yet more preferably 0.01 μm or more and 0.5 μm or less.

Examples of the dispersing agent added to further stabilize the dispersion stability of the coloring agent in the water medium and decrease the energy of the coloring agent in the toner include rosin, rosin derivatives, coupling agents, and polymer dispersing agents.

### Releasing Agent Particle Dispersion

The releasing agent particle dispersion is a dispersion obtained by dispersing at least a releasing agent in a water medium.

Examples of the releasing agent include hydrocarbon wax; natural wax such as carnauba wax, rice wax, and candelilla wax; synthetic or mineral or petroleum wax such as montan wax; and ester wax such as fatty acid esters and montanic acid esters. The releasing agent is not limited to these.

These releasing agents may be used alone or in combination.

The melting temperature of the releasing agent is preferably 50° C. or higher and 110° C. or lower and more preferably 60° C. or higher and 100° C. or lower.

The melting temperature is determined from a DSC curve obtained by differential scanning calorimetry (DSC) by the method described in “Melting peak temperature”, which is one method for determining the melting temperature in JIS K 7121-1987 “Testing Methods for Transition Temperatures of Plastics”.

The releasing agent is dispersed in a water medium by a known method, and, for example, medium dispersers such as a rotary shear homogenizer, a ball mill, a sand mill, and an attritor, and a high-pressure collision dispersers can be used. Alternatively, the releasing agent may be dispersed in a water medium by using a polar ionic surfactant and a homogenizer to prepare a releasing agent particle dispersion.

The volume-average particle diameter of the releasing agent particles is preferably or 1 μm or less and more preferably 0.01 μm or more and 1 μm or less.

### First Aggregation Step

A first aggregation step will now be described.

In the first aggregation step, first amorphous resin particles, crystalline resin particles, coloring agent particles, and releasing agent particles that are contained in a dispersion are caused to aggregate.

For example, in the first aggregation step, first amorphous resin particles, a crystalline resin particle dispersion, a coloring agent particle dispersion, and a releasing agent particle dispersion are mixed, and the respective particles are aggregated in the obtained mixed dispersion.

In the mixed dispersion, the respective particles are subjected to hetero aggregation so as to form first aggregated particles that have a diameter close to the target diameter of the toner particles.

Specifically, for example, aggregation involves adding an aggregating agent to the mixed dispersion, adjusting the pH of the mixed dispersion to acidic (for example, a pH of 2 or more and 5 or less), adding a dispersion stabilizer as needed, and heating the resulting mixture to the glass transition temperature of the resin particles (specifically, for example, a temperature 30° C. to 10° C. lower than the glass transition temperature of the amorphous resin particles) to aggregate the particles dispersed in the mixed dispersion and to thereby form first aggregated particles.

In the first aggregation step, for example, the aforementioned heating may be performed after the aggregating agent is added to the mixed dispersion at room temperature (for example, 25° C.) under stirring with a rotary shear homogenizer, the pH of the mixed dispersion is adjusted to acidic (for example, a pH of 2 or more and 5 or less), and a dispersion stabilizer is added as necessary.

Examples of the aggregating agent include a surfactant having an opposite polarity to a surfactant used as a dispersing agent added to the mixed dispersion, an inorganic metal salt, and a divalent or higher metal complex. In particular, when a metal complex is used as the aggregating agent, the amount of the surfactant used is decreased, and the charge properties are improved.

An additive that forms a complex or a similar bond to the metal ion in the aggregating agent may be used as needed. For example, a chelating agent can be used as this additive.

Examples of the inorganic metal salt include metal salts such as calcium chloride, calcium nitrate, barium chloride, magnesium chloride, zinc chloride, aluminum chloride, and aluminum sulfate, and inorganic metal salt polymers such as polyaluminum chloride, polyaluminum hydroxide, and calcium polysulfide.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably 0.01 parts by mass or more and 5.0 parts by mass or less and more preferably 0.1 parts by mass or more and less than 3.0 parts by mass relative to 100 parts by mass of the amorphous resin particles.

### Second Aggregation Step

In the second aggregation step, in a dispersion containing the first aggregated particles obtained by aggregation of the first amorphous resin particles, and second amorphous resin particles, the second amorphous resin particles are aggregated around the first aggregated particles.

For example, in the second aggregation step, a first aggregated particle dispersion and a second amorphous resin particle dispersion are mixed, and, in the resulting mixed dispersion, the second amorphous resin particles are aggregated so as to attach to the surfaces of the first aggregated particles.

Specifically, for example, when the first aggregated particles have reached the target particle diameter in the first aggregation step, a second amorphous resin particle dispersion is added thereto, and the resulting dispersion is heated at a temperature higher than or equal to the glass transition temperature of the first and second amorphous resin particles. The aggregation operation is repeated at least once to form second aggregated particles.

Here, when the aggregation operation is to be performed at least twice (in other words, when the second aggregation step is performed multiple times), in at least one of the multiple times of performing aggregation other than the one performed last, the second amorphous resin particle dispersion and the releasing agent particle dispersion are added to the first aggregated particle dispersion, and the resulting dispersion is heated at a temperature equal to or lower than the glass transition temperature of the first and second amorphous resin particles. Here, the second amorphous resin particle dispersion and the releasing agent particle dispersion may be mixed in advance.

Next, after completion of the aggregation operation described above and after the second aggregated particles have reached the target particle diameter, the pH of the dispersion is adjusted to terminate progress of the aggregation.

### Fusing and Coalescing Step

In the fusing and coalescing step, the dispersion containing second aggregated particles is heated to fuse and coalesce the second aggregated particles to form toner particles.

For example, in the fusing and coalescing step, the dispersion containing the second aggregated particles is heated to a temperature equal to or higher than the glass transition temperature of the first and second amorphous resin particles (for example, a temperature 10° C. to 30° C. higher than the glass transition temperature of the first and second amorphous resin particles) so as to fuse and coalesce the second aggregated particles and form toner particles.

Here, upon completion of the fusing and coalescing step, the toner particles formed in the solution are subjected to a known washing step, a known solid-liquid separation step, and a known drying step to obtain dry toner particles.

The washing step may involve thorough substitution washing with ion exchange water from the standpoint of chargeability. The solid-liquid separation step is not particularly limited but can involve suction filtration, pressure filtration, or the like from the viewpoint of productivity. Although the drying step is also not particularly limited, from the viewpoint of productivity, freeze drying, air drying, flow drying, vibration flow drying, or the like can be employed.

Then, for example, an external additive is added to the obtained dry toner particles. The mixing may be conducted by using a V blender, a HENSCHEL mixer, a Lodige mixer, or the like, for example. Furthermore, if necessary, coarse particles in the toner may be removed by using a vibrating sieving machine, an air sieving machine, or the like.

An example of the external additive is inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)n, Al₂O₃·SiO₂, CaCO₃, MgCO₃, BaSO₄, and MgSO_{4.}

The surfaces of the inorganic particles used as an external additive may be hydrophobized. Hydrophobizing involves, for example, dipping inorganic particles in a hydrophobizing agent. The hydrophobizing agent is not particularly limited, and examples thereof include a silane coupling agent, a silicone oil, a titanate coupling agent, and an aluminum coupling agent. These may be used alone or in combination.

The amount of the hydrophobizing agent is usually, for example, 1 part by mass or more and 10 parts by mass or less relative to 100 parts by mass of the inorganic particles.

Examples of the external additive also include resin particles (resin particles of polystyrene, polymethyl methacrylate (PMMA), melamine resin, and the like) and cleaning active agents (for example, particles of higher aliphatic acid metal salts such as zinc stearate and fluorine polymers).

The external addition amount of the external additive is, for example, preferably 0.01 mass % or more and 5 mass % or less and more preferably 0.01 mass % or more and 2.0 mass % or less relative to the toner particles.

### Properties and Other Features of Toner Particles

The properties of the toner particles obtained by the toner production method of the exemplary embodiment are as follows.

The volume-average particle diameter (D50v) of the toner particles is preferably 2 μm or more and 15 μm or less and more preferably 4 μm or more and 8 μm or less.

Various types of average particle diameters and particle size distribution indices of the toner particles are measured by using Coulter Multisizer II (produced by Beckman Coulter Inc.) with ISOTON-II (produced by Beckman Coulter Inc.) as the electrolyte.

In measurement, 0.5 mg or more and 50 mg or less of a measurement sample is added to 2 mL of a 5% aqueous solution of a surfactant (for example, sodium alkyl benzenesulfonate) serving as the dispersing agent. The resulting mixture is added to 100 mL or more and 150 mL or less of the electrolyte.

The electrolyte in which the sample has been suspended is dispersed for 1 minute with an ultrasonic disperser, and the particle size distribution of the particles having a particle diameter in the range of 2 μm or more and 60 μm or less is measured by using Coulter Multisizer II with an aperture having a diameter of 100 μm. Here, the number of particles sampled is 50000.

Cumulative distributions of the volume and number are each plotted from the small diameter size relative to the particle size ranges (channels) split on the basis of the particle size distribution to be measured, and the particle diameter at 16% accumulation is defined as a volume particle diameter D16v and a number particle diameter D16p, the particle diameter at 50% accumulation is defined as a volume-average particle diameter D50v and a number average particle diameter D50p, and the particle diameter at 84% accumulation is defined as a volume particle diameter D84v and a number particle diameter D84p.

From these values, the volume particle size distribution index (GSDv) is calculated as (D84v/D16v)^{1/2} and the number particle size distribution index (GSDp) is calculated as (D84p/D16p)^{1/2.}

The average circularity of the toner particles is preferably 0.94 or more and 1.00 or less and more preferably 0.95 or more and 0.98 or less.

The average circularity of the toner particles is determined by (circle-equivalent perimeter)/(perimeter) [(perimeter of the circle having the same projection area as the particle image)/(perimeter of particle projection image)]. Specifically, it is the value measured by the following method.

First, toner particles to be measured are sampled by suction so as to form a flat flow, and particle images are captured as a still image by performing instantaneous strobe light emission. The particle image is analyzed by a flow particle image analyzer (FPIA-3000 produced by Sysmex Corporation) to determine the average circularity. The number of particles sampled in determining the average circularity is 3500.

When the toner contains an external additive, the toner (developer) to be measured is dispersed in surfactant-containing water, and then ultrasonically processed to obtain toner particles from which the external additive has been removed.

### Electrostatic Charge Image Developer

The electrostatic charge image developer according to an exemplary embodiment contains at least the toner of this exemplary embodiment.

The electrostatic charge image developer of this exemplary embodiment may be a one-component developer that contains only the toner according to this exemplary embodiment, or may be a two-component developer that is a mixture of the toner and a carrier.

The carrier is not particularly limited, and examples thereof include known carriers. Examples of the carrier include a coated carrier obtained by covering a surface of a core formed of a magnetic powder with a coating resin; a magnetic powder-dispersed carrier in which a magnetic powder is dispersed and blended in a matrix resin; and a resin-impregnated carrier in which a porous magnetic powder is impregnated with a resin.

The magnetic powder-dispersed carrier and the resin-impregnated carrier may be a carrier constituted by cores covered with a coating resin.

Examples of the magnetic powder include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylate copolymer, an organosiloxane bond-containing straight silicone resin and modified products thereof, a fluororesin, polyester, polycarbonate, phenolic resin, and epoxy resin.

The coating resin and the matrix resin may each contain other additives such as conductive particles.

Examples of the conductive particles include particles of metals such as gold, silver, and copper, carbon black, titanium oxide, zinc oxide, tin oxide, barium sulfate, aluminum borate, and potassium titanate.

Here, an example of the method for covering the surface of the core with the coating resin is a method that involves coating the surface of the core with a coating layer-forming solution prepared by dissolving the coating resin and, as necessary, various additives in an appropriate solvent. The solvent is not particularly limited and may be selected by taking into account the coating resin to be used, application suitability, etc.

Specific examples of the resin coating method include a dipping method that involves dipping a core in a coating layer-forming solution, a spraying method that involves spraying a coating layer-forming solution onto the surface of a core, a flow bed method that involves spraying a coating layer-forming solution while the core is floated on flowing air, and a kneader coater method that involves mixing the core formed of a carrier and a coating layer-forming solution in a kneader coater and then removing the solvent.

The toner-to-carrier mixing ratio (mass ratio) of the two-component developer is preferably toner:carrier=1:100 to 30:100 and more preferably 3:100 to 20:100.

### Image Forming Apparatus and Image Forming Method

An image forming apparatus and an image forming method according to this exemplary embodiment will now be described.

The image forming apparatus according to this exemplary embodiment includes an image carrying body, a charging unit that charges a surface of the image carrying body, an electrostatic charge image forming unit that forms an electrostatic charge image on the charged surface of the image carrying body, a developing unit that stores the electrostatic charge image developer and develops the electrostatic charge image on the surface of the image carrying body into a toner image by using the electrostatic charge image developer, a transfer unit that transfers the toner image on the surface of the image carrying body onto a surface of a recording medium, and a fixing unit that fixes the transferred toner image onto the surface of the recording medium. The electrostatic charge image developer of this exemplary embodiment is employed as this electrostatic charge image developer.

The image forming apparatus according to this exemplary embodiment is used to perform an image forming method (the image forming method according to this exemplary embodiment) that includes a charging step of charging a surface of an image carrying body, an electrostatic charge image forming step of forming an electrostatic charge image on the charged surface of the image carrying body, a developing step of developing the electrostatic charge image on the surface of the image carrying body into a toner image by using the electrostatic charge image developer of the exemplary embodiment, a transfer step of transferring the toner image on the surface of the image carrying body onto a surface of a recording medium, and a fixing step of fixing the transferred toner image onto the surface of the recording medium.

A known image forming apparatus is applied as the image forming apparatus of this exemplary embodiment. Examples of the known image forming apparatus include a direct transfer type apparatus with which a toner image formed on a surface of an image carrying body is directly transferred onto a recording medium; an intermediate transfer type apparatus with which a toner image formed on a surface of an image carrying body is first transferred onto a surface of an intermediate transfer body and then the toner image on the intermediate transfer body is transferred for the second time onto a surface of a recording medium; an apparatus equipped with a cleaning unit that cleans the surface of an image carrying body after the toner image transfer and before charging; and an apparatus equipped with a charge erasing unit that irradiates the surface of an image carrying body with charge erasing light to remove charges after the toner image transfer and before charging.

When an intermediate transfer type apparatus is to be employed, the transfer unit is equipped with, for example, an intermediate transfer body having a surface onto which a toner image is transferred, a first transfer unit that transfers the toner image on the surface of the image carrying body onto the surface of the intermediate body, and a second transfer unit that transfers the toner image on the surface of the intermediate transfer body onto a surface of a recording medium.

In the image forming apparatus of this exemplary embodiment, for example, a section that includes the developing unit may have a cartridge structure (process cartridge) that can be attached to and detached from the image forming apparatus. For example, the process cartridge can be equipped with a developing unit that stores the electrostatic charge image developer of the exemplary embodiment.

Hereinafter, one example of the image forming apparatus of the exemplary embodiment is described, but the image forming apparatus is not limited by the description below. The relevant parts illustrated in the drawings are described, and description of other parts is omitted.

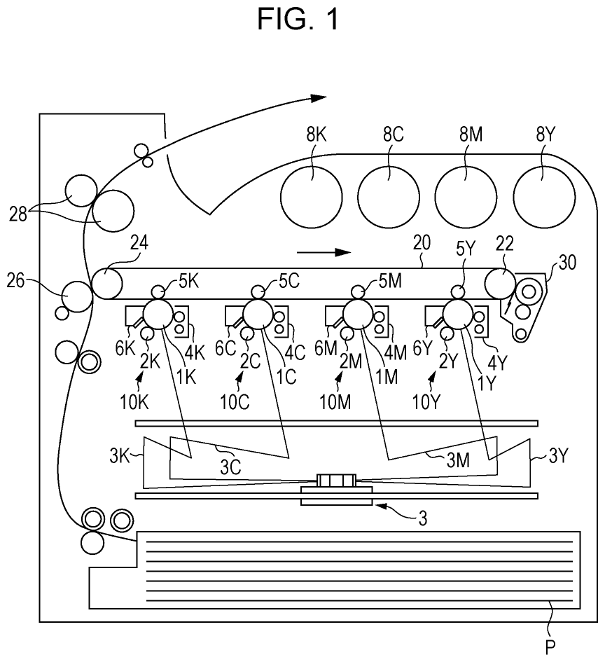

FIG. 1 is a schematic diagram illustrating an image forming apparatus according to an exemplary embodiment.

The image forming apparatus illustrated in FIG. 1 is equipped with first to fourth image forming units 10Y, 10M, 10C, and 10K (image forming units) of an electrophotographic type configured to output images of respective colors, yellow (Y), magenta (M), cyan (C), and black (K), on the basis of the color separated image data. These image forming units (hereinafter may be simply referred to as “units”) 10Y, 10M, 10C, and 10K are disposed side-by-side separated from each other by a predetermined distance in the horizontal direction. These units 10Y, 10M, 10C, and 10K may be process cartridges that can be attached to and detached from the image forming apparatus.

An intermediate transfer belt 20 that serves as an intermediate transfer body for all of the units 10Y, 10M, 10C, and 10K extends above the units 10Y, 10M, 10C, and 10K as viewed in the drawing. The intermediate transfer belt 20 is wound around a drive roll 22 and a support roll 24 that are arranged to be spaced from each other in the left-to-right direction in the drawing. The support roll 24 is in contact with the inner surface of the intermediate transfer belt 20, and the intermediate transfer belt 20 runs in a direction from the first unit 10Y toward the fourth unit 10K. A force that urges the support roll 24 to move in a direction away from the drive roll 22 is applied to the support roll 24 by a spring or the like not illustrated in the drawing so that a tension is applied to the intermediate transfer belt 20 wound around the support roll 24 and the drive roll 22. In addition, an intermediate transfer body cleaning device 30 that faces the drive roll 22 is disposed on the surface of the intermediate transfer belt 20 that carries the images.

Toners of four colors, yellow, magenta, cyan, and black, are stored in toner cartridges 8Y, 8M, 8C, and 8K and supplied to developing devices (developing units) 4Y, 4M, 4C, and 4K of the units 10Y, 10M, 10C, and 10K.

Since the first to fourth units 10Y, 10M, 10C, and 10K are identical in structure, only the first unit 10Y that forms a yellow image and is disposed on the upstream side of the intermediate transfer belt running direction is described as a representative example in the description below. Note that parts equivalent to those of the first unit 10Y are referred by reference signs having magenta (M), cyan (C), or black (K) added thereto instead of yellow (Y) to omit the descriptions of the second to fourth units 10M, 10C, and 10K.

The first unit 10Y has a photoreceptor 1Y that serves as an image carrying body. A charging roll (one example of the charging unit) 2Y that charges the surface of the photoreceptor 1Y to a predetermined potential, the exposing device (one example of the electrostatic charge image forming unit) 3 that forms an electrostatic charge image by exposing the charged surface with a laser beam 3Y on the basis of a color-separated image signal, a developing device (one example of the developing unit) 4Y that develops the electrostatic charge image by supplying the charged toner to the electrostatic charge image, a first transfer roll 5Y (one example of the first transfer unit) that transfers the developed toner image onto the intermediate transfer belt 20, and a photoreceptor cleaning device (one example of the cleaning unit) 6Y that removes the toner remaining on the surface of the photoreceptor 1Y after the first transfer are arranged in the order around the photoreceptor 1Y.

The first transfer roll 5Y is disposed on the inner side of the intermediate transfer belt 20 and faces the photoreceptor 1Y. Furthermore, each of the first transfer rolls 5Y, 5M, 5C, and 5K is connected to a bias power supply (not illustrated) that applies a first transfer bias. The bias power supplies control and vary the transfer biases to be applied to the respective first transfer rolls by controllers not illustrated in the drawing.

Hereinafter, the operation of forming a yellow image in the first unit 10Y is described.

First, prior to the operation, the surface of the photoreceptor 1Y is charged to a potential of −600 V to −800 V by the charging roll 2Y.

The photoreceptor 1Y is formed by forming a photosensitive layer on a conductive (for example, the volume resistivity of 1×10⁻⁶ Ωcm or less at 20° C.) substrate. This photosensitive layer usually has high resistance (resistance of resins in general) but has a property that the part irradiated with a laser beam 3Y undergoes a change in resistivity. Thus the laser beam 3Y is output toward the charged surface of the photoreceptor 1Y through the exposing device 3 according to the yellow image data sent from a controller not illustrated in the drawing. The laser beam 3Y irradiates the photosensitive layer on the surface of the photoreceptor 1Y and thereby forms an electrostatic charge image of a yellow image pattern on the surface of the photoreceptor 1Y.

The electrostatic charge image is an image formed on the surface of the photoreceptor 1Y as a result of charging, and is a so-called negative latent image formed by the charges remaining in the portion of the photosensitive layer not irradiated with the laser beam 3Y as the charges on the surface of the photoreceptor 1Y in the portion of the photosensitive layer irradiated with the laser beam 3Y flow due to the decreased resistivity of the irradiated portion.

The electrostatic charge image on the photoreceptor 1Y is rotated to a predetermined development position as the photoreceptor 1Y is run. Then at this development position, the electrostatic charge image on the photoreceptor 1Y is visualized (developed image) into a toner image by the developing device 4Y.

For example, an electrostatic charge image developer that contains at least a yellow toner and a carrier is stored in the developing device 4Y. The yellow toner is frictionally charged by being stirred in the developing device 4Y and is carried on a developer roll (an example of a developer carrying member) by having charges of the same polarity (negative polarity) as the charges on the photoreceptor 1Y. Then as the surface of the photoreceptor 1Y passes the developing device 4Y, the yellow toner electrostatically adheres to the latent image portion from which the charges on the surface of the photoreceptor 1Y have been removed, and thus the latent image is developed with the yellow toner. The photoreceptor 1Y on which the yellow toner image has been formed is continuously run at a predetermined speed, and the toner image developed on the photoreceptor 1Y is conveyed to a predetermined first transfer position.

As the yellow toner image on the photoreceptor 1Y is conveyed to the first transfer position, a first transfer bias is applied to the first transfer roll 5Y, an electrostatic force acting from the photoreceptor 1Y toward the first transfer roll 5Y acts on the toner image, and the toner image on the photoreceptor 1Y is transferred onto the intermediate transfer belt 20. The transfer bias applied here has a polarity (+) opposite of the polarity (−) of the toner, and, for example, the transfer bias is controlled to +10 μA by a controller (not illustrated) in the first unit 10Y.

Meanwhile, the toner remaining on the photoreceptor 1Y is removed and recovered by the photoreceptor cleaning device 6Y.

The first transfer biases applied to the first transfer rolls 5M, 5C, and 5K of the second unit 10M and onward are controlled in accordance with the first unit.

As such, the intermediate transfer belt 20 onto which the yellow toner image has been transferred in the first unit 10Y is sequentially conveyed through the second to fourth units 10M, 10C, and 10K, and toner images of respective colors are superimposed on each other (multiple transfer).

The intermediate transfer belt 20 onto which the toner images of four colors have been transferred through the first to fourth units reaches a second transfer section constituted by the intermediate transfer belt 20, the support roll 24 in contact with the inner surface of the intermediate transfer belt 20, and a second transfer roll (one example of the second transfer unit) 26 disposed on the image-carrying surface-side of the intermediate transfer belt 20. Meanwhile, a supplying mechanism supplies a recording sheet (one example of the recording medium) P, at a predetermined timing, to a gap between the second transfer roll 26 and the intermediate transfer belt 20 in contact with each other, and a second transfer bias is applied to the support roll 24. The transfer bias applied at this stage has the same polarity (−) as the polarity (−) of the toner, and an electrostatic force acting from the intermediate transfer belt 20 toward the recording sheet P acts on the toner image, and the toner image on the intermediate transfer belt is transferred onto the recording sheet P. Here, the second transfer bias is determined on the basis of the resistance detected with a resistance detection unit (not illustrated) that detects the resistance of the second transfer section, and is voltage-controlled.

Subsequently, the recording sheet P is sent into a contact section (nip section) between a pair of fixing rolls of a fixing device (one example of the fixing unit) 28, and the toner image is fixed onto the recording sheet P to form a fixed image.

Examples of the recording sheet P used to transfer the toner image include regular paper used in electrophotographic copier and printers, etc. The recording medium may be OHP sheets and the like instead of the recording sheet P.

In order to further improve the smoothness of the image surface after fixing, the surface of the recording sheet P can also be smooth, and examples of such a recording sheet P include coated paper obtained by coating the surface of regular paper with a resin or the like, and art paper used in printing.

The recording sheet P after completion of fixing of the color image is conveyed toward a discharge section, thereby terminating a series of color image forming operations.

### Process Cartridge and Toner Cartridge

A process cartridge according to an exemplary embodiment will now be described.

The process cartridge of this exemplary embodiment is equipped with a developing unit that stores the electrostatic charge image developer of the exemplary embodiment and develops an electrostatic charge image on the surface of an image carrying body into a toner image by using the electrostatic charge image developer, and is detachably attachable to an image forming apparatus.

The process cartridge of this exemplary embodiment is not limited to the aforementioned structure, and may be have a structure that includes a developing device and, if needed, at least one selected from other units, for example, an image carrying body, a charging unit, an electrostatic charge image forming unit, and a transfer unit.

Hereinafter, one example of the process cartridge according to the exemplary embodiment is described, but the process cartridge is not limited by the description below. The relevant parts illustrated in the drawings are described, and description of other parts is omitted.

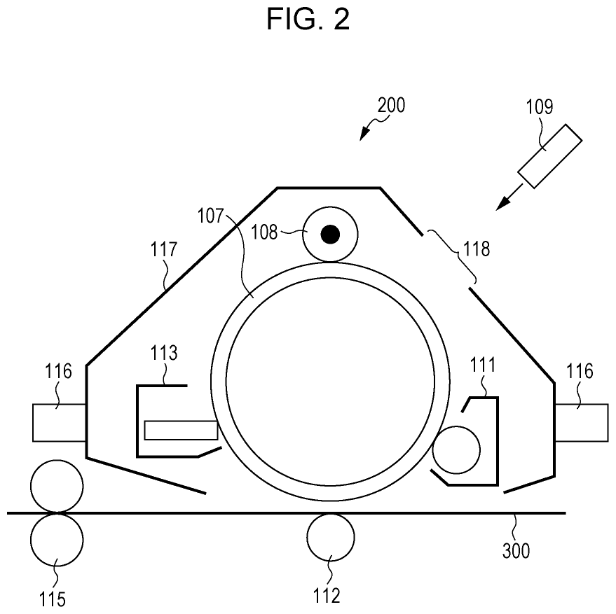

FIG. 2 is a schematic diagram illustrating a process cartridge of an exemplary embodiment.

A process cartridge 200 illustrated in FIG. 2 is constituted by a casing 117 equipped with a guide rail 116 and an opening 118 for exposure, the casing integrating a photoreceptor 107 (one example of the image carrying body), a charging roll 108 (one example of the charging unit) disposed around the photoreceptor 107, a developing unit 111 (one example of the developing unit), and a photoreceptor cleaning unit 113 (one example of the cleaning unit) to form a cartridge.

Note that in FIG. 2, 109 denotes an exposure device (one example of the electrostatic charge image forming unit), 112 denotes a transfer device (one example of the transfer unit), 115 denotes a fixing device (one example of the fixing unit), and 300 denotes a recording sheet (one example of the recording medium).

Next, a toner cartridge according to an exemplary embodiment is described.

The toner cartridge of this exemplary embodiment stores the toner of the exemplary embodiment and is detachably attachable to an image forming apparatus. The toner cartridge stores replenishment toner to be supplied to the developing unit in the image forming apparatus.

The image forming apparatus illustrated in FIG. 1 is of a type that the toner cartridges 8Y, 8M, 8C, and 8K are detachably attachable, and the developing devices 4Y, 4M, 4C, and 4K are respectively connected to the toner cartridges corresponding to the respective developing devices (colors) through toner supply tubes. Moreover, when the toner in the toner cartridge runs low, the toner cartridge is replaced.

### EXAMPLES

Hereinafter, the exemplary embodiments of the present disclosure are described in details through examples, but these examples are not limiting.

In the description below, the “parts” and “%” are on a mass basis unless otherwise noted.

Synthesis, processes, preparations, etc., are conducted at room temperature (25° C. ±3° C.) unless otherwise noted.

### Preparation of Particle Dispersions

### Preparation of Amorphous Polyester Resin Particle Dispersion (A1)

terephthalic acid: 69 parts
fumaric acid: 31 parts
ethylene glycol: 40 parts
1,5-pentanediol: 45 parts

The aforementioned materials are placed in a reaction vessel equipped with a stirrer, a nitrogen inlet tube, a temperature sensor, and a distillation column, the temperature is elevated to 220° C. over a period of 1 hour under nitrogen gas stream, and 1 part of titanium tetraethoxide is added to a total of 100 parts of the aforementioned materials. The temperature is elevated to 240° C. over a period of 0.5 hours while distilling away the generated water, dehydration and condensation reaction is continued for 1 hour at 240° C., and then the reaction product is cooled. As a result, an amorphous polyester resin (A) having a weight-average molecular weight of 96000 and a glass transition temperature of 59° C. is obtained.

Into a vessel equipped with a temperature adjusting unit and a nitrogen purging unit, 53 parts of ethyl acetate and 25 parts of 2-butanol are placed to prepare a mixed solvent, and then 100 parts of the amorphous polyester resin (A) is gradually added thereto to be dissolved. Thereto, a 10% aqueous ammonia solution (amount equivalent to a molar ratio of 3 relative to the acid value of the resin) is added, and the resulting mixture is stirred for 30 minutes. Next, the inside of the reactor is substituted with dry nitrogen, the temperature is retained at 40° C., and 400 parts of ion exchange water is added dropwise while stirring the mixed solution so as to conduct emulsification. Upon completion of the dropwise addition, the emulsion is returned to 25° C., the solvent is removed at a reduced pressure, and, as a result, a resin particle dispersion containing dispersed resin particles having a volume-average particle diameter of 170 nm is obtained. To this resin particle dispersion, ion exchange water is added to adjust the solid content to 20% so as to obtain an amorphous polyester resin particle dispersion (A1).

### Preparation of Amorphous Polyester Resin Particle Dispersion (A2)

An amorphous polyester resin particle dispersion (A2) having a volume-average particle diameter of 70 nm and a solid content of 20% is obtained as with the amorphous polyester resin particle dispersion (A1) using the amorphous polyester resin (A) except that 53 parts of ethyl acetate is changed to 80 parts of ethyl acetate.

### Preparation of Amorphous Polyester Resin Particle Dispersion (A3)

An amorphous polyester resin particle dispersion (A3) having a volume-average particle diameter of 220 nm and a solid content of 20% is obtained as with the amorphous polyester resin particle dispersion (A1) using the amorphous polyester resin (A) except that 53 parts of ethyl acetate is changed to 47 parts of ethyl acetate.

### Preparation of Amorphous Polyester Resin Particle Dispersion (A4)

An amorphous polyester resin particle dispersion (A4) having a volume-average particle diameter of 130 nm and a solid content of 20% is obtained as with the amorphous polyester resin particle dispersion (A1) using the amorphous polyester resin (A) except that 53 parts of ethyl acetate is changed to 64 parts of ethyl acetate.

### Preparation of Amorphous Polyester Resin Particle Dispersion (A5)

An amorphous polyester resin particle dispersion (A5) having a volume-average particle diameter of 150 nm and a solid content of 20% is obtained as with the amorphous polyester resin particle dispersion (A1) using the amorphous polyester resin (A) except that 53 parts of ethyl acetate is changed to 58 parts of ethyl acetate.

### Preparation of Amorphous Polyester Resin Particle Dispersion (A6)

An amorphous polyester resin particle dispersion (A6) having a volume-average particle diameter of 80 nm and a solid content of 20% is obtained as with the amorphous polyester resin particle dispersion (A1) using the amorphous polyester resin (A) except that 53 parts of ethyl acetate is changed to 75 parts of ethyl acetate.

### Preparation of Amorphous Polyester Resin Particle Dispersion (A7)

An amorphous polyester resin particle dispersion (A7) having a volume-average particle diameter of 100 nm and a solid content of 20% is obtained as with the amorphous polyester resin particle dispersion (A1) using the amorphous polyester resin (A) except that 53 parts of ethyl acetate is changed to 66 parts of ethyl acetate.

### Preparation of Amorphous Polyester Resin Particle Dispersion (A8)

An amorphous polyester resin particle dispersion (A8) having a volume-average particle diameter of 90 nm and a solid content of 20% is obtained as with the amorphous polyester resin particle dispersion (A1) using the amorphous polyester resin (A) except that 53 parts of ethyl acetate is changed to 68 parts of ethyl acetate.

### Preparation of Amorphous Polyester Resin Particle Dispersion (A9)

An amorphous polyester resin particle dispersion (A9) having a volume-average particle diameter of 50 nm and a solid content of 20% is obtained as with the amorphous polyester resin particle dispersion (A1) using the amorphous polyester resin (A) except that 53 parts of ethyl acetate is changed to 85 parts of ethyl acetate.

### Preparation of Amorphous Polyester Resin Particle Dispersion (A10)

An amorphous polyester resin particle dispersion (A10) having a volume-average particle diameter of 300 nm and a solid content of 20% is obtained as with the amorphous polyester resin particle dispersion (A1) using the amorphous polyester resin (A) except that 53 parts of ethyl acetate is changed to 40 parts of ethyl acetate.

### Preparation of Amorphous Polyester Resin Particle Dispersion (A11)

An amorphous polyester resin particle dispersion (A11) having a volume-average particle diameter of 320 nm and a solid content of 20% is obtained as with the amorphous polyester resin particle dispersion (A1) using the amorphous polyester resin (A) except that 53 parts of ethyl acetate is changed to 39 parts of ethyl acetate.

### Preparation of Amorphous Polyester Resin Particle Dispersion (A12)

An amorphous polyester resin particle dispersion (A12) having a volume-average particle diameter of 12 nm and a solid content of 20% is obtained as with the amorphous polyester resin particle dispersion (A1) using the amorphous polyester resin (A) except that 53 parts of ethyl acetate is changed to 105 parts of ethyl acetate.

### Preparation of Amorphous Polyester Resin Particle Dispersion (A13)

An amorphous polyester resin particle dispersion (A13) having a volume-average particle diameter of 30 nm and a solid content of 20% is obtained as with the amorphous polyester resin particle dispersion (A1) using the amorphous polyester resin (A) except that 53 parts of ethyl acetate is changed to 90 parts of ethyl acetate.

### Preparation of Amorphous Polyester Resin Particle Dispersion (A14)

An amorphous polyester resin particle dispersion (A14) having a volume-average particle diameter of 180 nm and a solid content of 20% is obtained as with the amorphous polyester resin particle dispersion (A1) using the amorphous polyester resin (A) except that 53 parts of ethyl acetate is changed to 51 parts of ethyl acetate.

### Preparation of Amorphous Polyester Resin Particle Dispersion (B1)

terephthalic acid: 69 parts
fumaric acid: 31 parts
ethylene glycol: 40 parts
1,5-pentanediol: 45 parts

The aforementioned materials are placed in a reaction vessel equipped with a stirrer, a nitrogen inlet tube, a temperature sensor, and a distillation column, the temperature is elevated to 220° C. over a period of 0.8 hours under nitrogen gas stream, and 1.1 parts of titanium tetraethoxide is added to a total of 100 parts of the aforementioned materials. The temperature is elevated to 240° C. over a period of 0.4 hours while distilling away the generated water, dehydration and condensation reaction is continued for 0.9 hours at 240° C., and then the reaction product is cooled. As a result, an amorphous polyester resin (B1) having a weight-average molecular weight of 96000 and a glass transition temperature of 50° C. is obtained.

Into a vessel equipped with a temperature adjusting unit and a nitrogen purging unit, 52 parts of ethyl acetate and 25 parts of 2-butanol are placed to prepare a mixed solvent, and then 100 parts of the amorphous polyester resin (B1) is gradually added thereto to be dissolved. Thereto, a 10% aqueous ammonia solution (amount equivalent to a molar ratio of 3 relative to the acid value of the resin) is added, and the resulting mixture is stirred for 30 minutes. Next, the inside of the reactor is substituted with dry nitrogen, the temperature is retained at 40° C., and 400 parts of ion exchange water is added dropwise while stirring the mixed solution so as to conduct emulsification. Upon completion of the dropwise addition, the emulsion is returned to 25° C., the solvent is removed at a reduced pressure, and, as a result, a resin particle dispersion containing dispersed resin particles having a volume-average particle diameter of 175 nm is obtained. To this resin particle dispersion, ion exchange water is added to adjust the solid content to 20% so as to obtain an amorphous polyester resin particle dispersion (B1).

### Preparation of Amorphous Polyester Resin Particle Dispersion (B2)

Into a vessel equipped with a temperature adjusting unit and a nitrogen purging unit, 53 parts of ethyl acetate and 25 parts of 2-butanol are placed to prepare a mixed solvent, and then 100 parts of the amorphous polyester resin (B1) is gradually added thereto to be dissolved. Thereto, a 10% aqueous ammonia solution (amount equivalent to a molar ratio of 3 relative to the acid value of the resin) is added, and the resulting mixture is stirred for 30 minutes. Next, the inside of the reactor is substituted with dry nitrogen, the temperature is retained at 40° C., and 400 parts of ion exchange water is added dropwise while stirring the mixed solution so as to conduct emulsification. Upon completion of the dropwise addition, the emulsion is returned to 25° C., the solvent is removed at a reduced pressure, and, as a result, a resin particle dispersion containing dispersed resin particles having a volume-average particle diameter of 170 nm is obtained. To this resin particle dispersion, ion exchange water is added to adjust the solid content to 20% so as to obtain an amorphous polyester resin particle dispersion (B2).

### Preparation of Amorphous Polyester Resin Particle Dispersion (B3)

terephthalic acid: 69 parts
fumaric acid: 31 parts
ethylene glycol: 40 parts
1,5-pentanediol: 45 parts

The aforementioned materials are placed in a reaction vessel equipped with a stirrer, a nitrogen inlet tube, a temperature sensor, and a distillation column, the temperature is elevated to 220° C. over a period of 1.3 hours under nitrogen gas stream, and 0.9 parts of titanium tetraethoxide is added to a total of 100 parts of the aforementioned materials. The temperature is elevated to 240° C. over a period of 0.6 hours while distilling away the generated water, dehydration and condensation reaction is continued for 1.2 hours at 240° C., and then the reaction product is cooled. As a result, an amorphous polyester resin (B3) having a weight-average molecular weight of 96000 and a glass transition temperature of 63° C. is obtained.

Into a vessel equipped with a temperature adjusting unit and a nitrogen purging unit, 53 parts of ethyl acetate and 25 parts of 2-butanol are placed to prepare a mixed solvent, and then 100 parts of the amorphous polyester resin (B3) is gradually added thereto to be dissolved. Thereto, a 10% aqueous ammonia solution (amount equivalent to a molar ratio of 3 relative to the acid value of the resin) is added, and the resulting mixture is stirred for 30 minutes. Next, the inside of the reactor is substituted with dry nitrogen, the temperature is retained at 40° C., and 400 parts of ion exchange water is added dropwise while stirring the mixed solution so as to conduct emulsification. Upon completion of the dropwise addition, the emulsion is returned to 25° C., the solvent is removed at a reduced pressure, and, as a result, a resin particle dispersion containing dispersed resin particles having a volume-average particle diameter of 170 nm is obtained. To this resin particle dispersion, ion exchange water is added to adjust the solid content to 20% so as to obtain an amorphous polyester resin particle dispersion (B3).

### Preparation of Amorphous Polyester Resin Particle Dispersion (B4)

terephthalic acid: 69 parts
fumaric acid: 31 parts
ethylene glycol: 40 parts
1,5-pentanediol: 45 parts

The aforementioned materials are placed in a reaction vessel equipped with a stirrer, a nitrogen inlet tube, a temperature sensor, and a distillation column, the temperature is elevated to 225° C. over a period of 0.6 hours under nitrogen gas stream, and 1.1 parts of titanium tetraethoxide is added to a total of 100 parts of the aforementioned materials. The temperature is elevated to 245° C. over a period of 0.3 hours while distilling away the generated water, dehydration and condensation reaction is continued for 0.9 hours at 245° C., and then the reaction product is cooled. As a result, an amorphous polyester resin (B4) having a weight-average molecular weight of 96000 and a glass transition temperature of 45° C. is obtained.

Into a vessel equipped with a temperature adjusting unit and a nitrogen purging unit, 52 parts of ethyl acetate and 25 parts of 2-butanol are placed to prepare a mixed solvent, and then 100 parts of the amorphous polyester resin (B4) is gradually added thereto to be dissolved. Thereto, a 10% aqueous ammonia solution (amount equivalent to a molar ratio of 3 relative to the acid value of the resin) is added, and the resulting mixture is stirred for 30 minutes. Next, the inside of the reactor is substituted with dry nitrogen, the temperature is retained at 40° C., and 400 parts of ion exchange water is added dropwise while stirring the mixed solution so as to conduct emulsification. Upon completion of the dropwise addition, the emulsion is returned to 25° C., the solvent is removed at a reduced pressure, and, as a result, a resin particle dispersion containing dispersed resin particles having a volume-average particle diameter of 175 nm is obtained. To this resin particle dispersion, ion exchange water is added to adjust the solid content to 20% so as to obtain an amorphous polyester resin particle dispersion (B4).

### Preparation of Amorphous Polyester Resin Particle Dispersion (B5)

Into a vessel equipped with a temperature adjusting unit and a nitrogen purging unit, 53 parts of ethyl acetate and 25 parts of 2-butanol are placed to prepare a mixed solvent, and then 100 parts of the amorphous polyester resin (B4) is gradually added thereto to be dissolved. Thereto, a 10% aqueous ammonia solution (amount equivalent to a molar ratio of 3 relative to the acid value of the resin) is added, and the resulting mixture is stirred for 30 minutes. Next, the inside of the reactor is substituted with dry nitrogen, the temperature is retained at 40° C., and 400 parts of ion exchange water is added dropwise while stirring the mixed solution so as to conduct emulsification. Upon completion of the dropwise addition, the emulsion is returned to 25° C., the solvent is removed at a reduced pressure, and, as a result, a resin particle dispersion containing dispersed resin particles having a volume-average particle diameter of 170 nm is obtained. To this resin particle dispersion, ion exchange water is added to adjust the solid content to 20% so as to obtain an amorphous polyester resin particle dispersion (B5).

### Preparation of Amorphous Polyester Resin Particle Dispersion (B6)

terephthalic acid: 69 parts
fumaric acid: 31 parts
ethylene glycol: 40 parts
1,5-pentanediol: 45 parts

The aforementioned materials are placed in a reaction vessel equipped with a stirrer, a nitrogen inlet tube, a temperature sensor, and a distillation column, the temperature is elevated to 220° C. over a period of 1.5 hours under nitrogen gas stream, and 0.8 parts of titanium tetraethoxide is added to a total of 100 parts of the aforementioned materials. The temperature is elevated to 240° C. over a period of 0.8 hours while distilling away the generated water, dehydration and condensation reaction is continued for 1.2 hours at 240° C., and then the reaction product is cooled. As a result, an amorphous polyester resin (B6) having a weight-average molecular weight of 96000 and a glass transition temperature of 67° C. is obtained.

Into a vessel equipped with a temperature adjusting unit and a nitrogen purging unit, 53 parts of ethyl acetate and 25 parts of 2-butanol are placed to prepare a mixed solvent, and then 100 parts of the amorphous polyester resin (B6) is gradually added thereto to be dissolved. Thereto, a 10% aqueous ammonia solution (amount equivalent to a molar ratio of 3 relative to the acid value of the resin) is added, and the resulting mixture is stirred for 30 minutes. Next, the inside of the reactor is substituted with dry nitrogen, the temperature is retained at 40° C., and 400 parts of ion exchange water is added dropwise, while stirring the mixed solution so as to conduct emulsification. Upon completion of the dropwise addition, the emulsion is returned to 25° C., the solvent is removed at a reduced pressure, and, as a result, a resin particle dispersion containing dispersed resin particles having a volume-average particle diameter of 170 nm is obtained. To this resin particle dispersion, ion exchange water is added to adjust the solid content to 20% so as to obtain an amorphous polyester resin particle dispersion (B3).

### Preparation of Crystalline Polyester Resin Particle Dispersion (C)

1,10-decanedicarboxylic acid: 260 parts
1,6-hexanediol: 167 parts
dibutyl tin oxide (catalyst): 0.3 parts

The aforementioned materials are placed in a heated and dried reaction vessel, the air inside the reaction vessel is purged with nitrogen gas to create an inert atmosphere, and the resulting mixture is mechanically stirred and refluxed at 180° C. for 5 hours. Next, the temperature is gradually elevated to 230° C. at a reduced pressure, stirring is continued for 2 hours, and the mixture is air-cooled after the mixture has turned viscous to terminate the reaction. As a result, a crystalline polyester resin having a weight- average molecular weight of 12600 and a melting temperature of 73° C. is obtained.

A mixture containing 90 parts of the crystalline polyester resin, 1.8 parts of an anionic surfactant (TaycaPower produced by TAYCA Co., Ltd.), and 210 parts of ion exchange water is heated to 120° C., dispersed by using a homogenizer (ULTRA-TURRAX T50 produced by IKA Japan), and then dispersed by a pressure discharge Gaulin homogenizer for 1 hour. As a result, a resin particle dispersion in which resin particles having a volume-average particle diameter of 160 nm are dispersed is obtained. To this resin particle dispersion, ion exchange water is added to adjust the solid content to 20% so as to obtain a crystalline polyester resin particle dispersion (C).

### Preparation of Releasing Agent Particle Dispersion (W1)

paraffin wax (FNP92 produced by produced by Nippon Seiro Co., Ltd., melting temperature: 92° C.): 100 parts
anionic surfactant (TaycaPower produced by TAYCA Co., Ltd.): 1 part
ion exchange water: 350 parts

The aforementioned materials are mixed, heated to 100° C., dispersed by using a homogenizer (ULTRA-TURRAX T50 produced by IKA Japan), and then dispersed by a pressure discharge Gaulin homogenizer. As a result, a releasing agent particle dispersion in which releasing agent particles having a volume-average particle diameter of 220 nm are dispersed is obtained. To this releasing agent particle dispersion, ion exchange water is added to adjust the solid content to 20% so as to obtain a releasing agent particle dispersion (W1).

### Preparation of Coloring Agent Particle Dispersion (K)

carbon black (Regal 330 produced by Cabot Corporation): 50 parts
anionic surfactant (NEOGEN RK produced by DKS Co., Ltd.):

5 parts
ion exchange water: 193 parts

The aforementioned materials are mixed and dispersed with an Ultimaizer (produced by SUGINO MACHINE LIMITED) at 240 MPa for 10 minutes so as to obtain a coloring agent particle dispersion (K) having a solid component concentration of 20%.

### Example 1

### First Aggregation Step

ion exchange water: 500 parts
amorphous polyester resin particle dispersion (A1): 530 parts
crystalline polyester resin particle dispersion (C): 150 parts
releasing agent particle dispersion (W1): 150 parts
coloring agent particle dispersion (K): 150 parts

The aforementioned materials are used as starting materials and placed in a reaction vessel, and the pH is adjusted to 3.5 by adding 0.1 N nitric acid.

An aqueous aluminum sulfate solution prepared by dissolving 1.5 parts of aluminum sulfate in 100 parts of ion exchange water is added to the reaction vessel.

The resulting mixture is dispersed at a liquid temperature of 30° C. by using a homogenizer (ULTRA-TURRAX T50 produced by IKA Japan), heated on a heating oil bath up to a liquid temperature of 45° C., and retained thereat until the volume-average particle diameter of the aggregated particles has reached 4.0 μm.

### Second Aggregation Step

To a dispersion containing aggregated particles, 90 parts of the amorphous polyester resin particle dispersion (A2) and 30 parts of the releasing agent particle dispersion (W1) are added as additional dispersants, and the resulting mixture is retained for 30 minutes.

To this dispersion containing the aggregated particles, 115 parts of the amorphous polyester resin particle dispersion (A2) is added as an additional dispersion, and the resulting mixture is retained for 30 minutes.

Next, the pH is adjusted to 9.0 by using a 1 N aqueous sodium hydroxide solution.

### Fusing and Coalescing Step

While continuing to stir the inside of the reaction vessel, the temperature is elevated at a rate of 0.5° C./minute up to 85° C., retained at 85° C. for 3 hours, and then decreased at a rate of 15° C./minute to 30° C. (first cooling). Next, the temperature is elevated at a rate of 0.2° C./minute up to 55° C. (reheating), retained thereat for 30 minutes, and then decreased at a rate of 0.5° C./minute to 30° C. (second cooling). Next, the solid components are separated by filtration, washed with ion exchange water, and dried. As a result, toner particles (K1) having a volume-average particle diameter of 5.0 μm are obtained.

### Addition of External Additive

One hundred parts of the toner particles (K1) and 1.5 parts of a hydrophobic silica (RY 50 produced by Nippon Aerosil Co., Ltd.) are mixed, and the resulting mixture is mixed for 30 seconds at a rotation rate of 10000 rpm with a sample mill. Subsequently, the resulting product is sieved through a vibrating sieve having 45 μm openings to obtain a toner (K1). The volume-average particle diameter of the toner (K1) is 5.0 μm.

### Preparation of Carrier

After 500 parts of spherical magnetite powder particles (volume-average particle diameter: 0.55 μm) are thoroughly stirred in a HENSCHEL mixer, 5 parts of a titanate coupling agent is added, and the resulting mixture is heated to 100° C. and then stirred for 30 minutes. Next, into a four-necked flask, 6.25 parts of phenol, 9.25 parts of 35% formalin, 500 parts of the magnetite particles treated with the titanate coupling agent, 6.25 parts of 25% ammonia water, and 425 parts of water are placed, and the resulting mixture is stirred, and reacted at 85° C. for 120 minutes under stirring. Next, after cooling to 25° C., 500 parts of water is added thereto, the supernatant is removed, and the deposits are washed with water. The washed deposits are dried by heating at a reduced pressure so as to obtain a carrier (CA) having an average particle diameter of 35 μm.

### Preparation of Developer

The toner (K1) and the carrier (CA) are placed in a V blender at a toner (K1):carrier (CA) =5:95 (mass ratio), and the resulting mixture is stirred for 20 minutes. As a result, a developer (K1) is obtained.

### Examples 2 to 17 and Comparative Examples 1 to 7

Toner particles are obtained as in Example 1 except for the changes indicated in Tables 1 and 2. Next, as in Example 1, an external additive is added to the toner particles, and the toner particles are mixed with a carrier to obtain a developer.

### Evaluation

### Solid Component Concentration of Dispersion in First Aggregation Step

In the first aggregation step, the solid component concentration of the dispersion is measured with a moisture analyzer (HB43-S produced by METTLER TOLEDO) when the dispersing by the homogenizer is completed.

### Particle Size Distribution (GSD) of Toner Particles and Exposure Ratio of Releasing Agent

For the obtained toner particles, the volume particle size distribution index (GSDv=(D84v/D16v)^{1/2}) and the exposure ratio of the releasing agent are measured according to the aforementioned methods.

The exposure ratio of the releasing agent is evaluated by the following standard.

A: The exposure ratio of the releasing agent is less than 15%.

B: The exposure ratio of the releasing agent is 15% or more but less than 20%.

C: The exposure ratio of the releasing agent is 20% or more but less than 25%.

D: The exposure ratio of the releasing agent is 25% or more but less than 100%.

TABLE 1

| | Starting material dispersant (for core) | | | Additional dispersant (for shell) | | | | |
|---|---|---|---|---|---|---|---|---|
| | Amorphous resin particle dispersion | | | amorphous resin particle dispersion | | | | |
| | | | Glass | | | | Proportion | Glass |
| | | Particle | transition | | Particle | Particle | of particles | transition |
| | | diameter | temper- | | diameter | diameter | 100 nm | temper- |
| | | DA | ature | | DB | D16p | or smaller | ature |
| | Type | (nm) | (° C.) | Type | (nm) | (nm) | (vol %) | (° C.) |
| Example 1 | A1 | 170 | 59 | A2 | 70 | 45 | 70 | 59 |
| Example 2 | A3 | 220 | 59 | A4 | 130 | 100 | 15 | 59 |
| Example 3 | A5 | 150 | 59 | A2 | 70 | 45 | 70 | 59 |
| Example 4 | A6 | 80 | 59 | A2 | 70 | 45 | 70 | 59 |
| Example 5 | A7 | 100 | 59 | A6 | 80 | 40 | 70 | 59 |
| Example 6 | A8 | 90 | 59 | A9 | 50 | 30 | 90 | 59 |
| Example 7 | A7 | 100 | 59 | A9 | 50 | 30 | 90 | 59 |
| Example 8 | A10 | 300 | 59 | A3 | 220 | 180 | 3 | 59 |
| Example 9 | A11 | 320 | 59 | A3 | 220 | 180 | 3 | 59 |
| Example 10 | A7 | 100 | 59 | A12 | 18 | 2 | 99 | 59 |
| Example 11 | A7 | 100 | 59 | A13 | 30 | 12 | 99 | 59 |
| Example 12 | A3 | 220 | 59 | A1 | 170 | 140 | 6 | 59 |
| Example 13 | A3 | 220 | 59 | A14 | 180 | 150 | 5 | 59 |
| Example 14 | A1 | 170 | 59 | A9 | 50 | 30 | 90 | 59 |
| | A14 | 180 | | A8 | 90 | 70 | 60 | |
| | | (after | | | (after | (after | (after | |
| | | mixing: 180) | | | mixing: 70) | mixing: 40) | mixing: 70) | |
| Example 15 | B1 | 175 | 50 | A1 | 170 | 140 | 6 | 59 |
| Example 16 | A14 | 180 | 59 | B2 | 170 | 140 | 5 | 50 |
| Example 17 | A14 | 180 | 59 | B3 | 170 | 140 | 8 | 63 |

| | | Solid | | |
|---|---|---|---|---|
| | | component | | |
| | | concentration | | |
| | | of dispersion | | Releasing |
| | | in first | | agent |
| | | aggregation | | exposure |
| | DA − DB | step | GSDv | ratio |
| Example 1 | 100 | 13 | 1.19 | A |
| Example 2 | 90 | 13 | 1.20 | A |
| Example 3 | 80 | 13 | 1.20 | A |
| Example 4 | 10 | 13 | 1.22 | A |
| Example 5 | 20 | 13 | 1.21 | A |
| Example 6 | 40 | 13 | 1.21 | A |
| Example 7 | 50 | 13 | 1.21 | A |
| Example 8 | 80 | 13 | 1.21 | A |
| Example 9 | 100 | 13 | 1.21 | A |
| Example 10 | 82 | 13 | 1.22 | A |
| Example 11 | 70 | 13 | 1.21 | A |
| Example 12 | 50 | 13 | 1.21 | A |
| Example 13 | 40 | 13 | 1.22 | A |
| Example 14 | 110 | 13 | 1.19 | A |
| Example 15 | 5 | 13 | 1.22 | A |
| Example 16 | 10 | 13 | 1.22 | A |
| Example 17 | 10 | 13 | 1.22 | A |

TABLE 2

| | Starting material dispersant (for core) | | | Additional dispersant (for shell) | | | | |
|---|---|---|---|---|---|---|---|---|
| | Amorphous resin particle dispersion | | | amorphous resin particle dispersion | | | | |
| | | | Glass | | | | Proportion | Glass |
| | | Particle | transition | | Particle | Particle | of particles | transition |
| | | diameter | temper- | | diameter | diameter | 100 nm | temper- |
| | | DA | ature | | DB | D16p | or smaller | ature |
| | Type | (nm) | (° C.) | Type | (nm) | (nm) | (vol %) | (° C.) |
| Comparative | A1 | 170 | 59 | A1 | 170 | 140 | 6 | 59 |
| Example 1 | | | | | | | | |
| Comparative | A7 | 100 | 59 | A1 | 170 | 140 | 6 | 59 |
| Example 2 | | | | | | | | |
| Comparative | A2 | 70 | 59 | A2 | 70 | 45 | 70 | 59 |
| Example 3 | | | | | | | | |
| Comparative | A2 | 70 | 59 | A2 | 70 | 45 | 70 | 59 |
| Example 4 | | | | | | | | |
| Comparative | B4 | 175 | 45 | A1 | 170 | 140 | 6 | 59 |
| Example 5 | | | | | | | | |
| Comparative | A14 | 180 | 59 | B5 | 170 | 140 | 4 | 45 |
| Example 6 | | | | | | | | |
| Comparative | A14 | 180 | 59 | B6 | 170 | 140 | 9 | 67 |
| Example 7 | | | | | | | | |

| | | Solid | | |
|---|---|---|---|---|
| | | component | | |
| | | concentration | | |
| | | of dispersion | | Releasing |
| | | in first | | agent |
| | | aggregation | | exposure |
| | DA − DB | step | GSDv | ratio |
| Comparative | 0 | 13 | 1.23 | C |
| Example 1 | | | | |
| Comparative | −70 | 13 | 1.25 | C |
| Example 2 | | | | |
| Comparative | 0 | 13 | 1.24 | C |
| Example 3 | | | | |
| Comparative | 0 | 11 | 1.24 (GSD on small | A |
| Example 4 | | | diameter side is poor) | |
| Comparative | 5 | 13 | 1.30 (aggregation is | A |
| Example 5 | | | difficult to control due | |
| | | | to resin glass | |
| | | | transition tempera- | |
| | | | ture ≤ aggregation | |
| | | | temperature) | |
| Comparative | 10 | 13 | 1.35 (aggregation is | A |
| Example 6 | | | difficult to control due | |
| | | | to resin glass | |
| | | | transition temper- | |
| | | | ature ≤ aggregation | |
| | | | temperature) | |
| Comparative | 10 | 13 | 1.23 | A |
| Example 7 | | | | |

These results show that the toners having a narrow particle size distribution are obtained in Examples compared to Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A method for producing a toner for developing an electrostatic charge image, the method comprising:
performing first aggregation that involves, in a dispersion containing first amorphous resin particles, aggregating at least the first amorphous resin particles;
performing second aggregation that involves, in a dispersion that contains second amorphous resin particles and first aggregated particles obtained by aggregating the first amorphous resin particles, aggregating the second amorphous resin particles around the first aggregated particles; and
heating a dispersion that contains second aggregated particles obtained by aggregating the second amorphous resin particles around the first aggregated particles so as to fuse and coalesce the second aggregated particles and form toner particles,
wherein:
a volume-average particle diameter DB of the second amorphous resin particles is smaller than a volume-average particle diameter DA of the first amorphous resin particles, and
the first amorphous resin particles have a glass transition temperature of 50° C. or higher, and the second amorphous resin particles have a glass transition temperature of 50° C. or higher and 63° C. or lower.

2. The method for producing a toner for developing an electrostatic charge image according to claim 1, wherein:
the second aggregation is performed multiple times, and
at least one of the multiple times of performing second aggregation other than the one performed last involves aggregating, in a dispersion, the second resin particles and releasing agent particles around the first aggregated particles, the dispersion containing the first aggregated particles, the second amorphous resin particles, and the releasing agent particles.

3. The method for producing a toner for developing an electrostatic charge image according to claim 2, wherein an exposure ratio of the releasing agent on surfaces of the obtained toner particles is 25% or less.

4. The method for producing a toner for developing an electrostatic charge image according to claim 1, wherein a difference (DA−DB) between the volume-average particle diameter DA of the first amorphous resin particles and the volume-average particle diameter DB of the second amorphous resin particles is 20 nm or more.

5. The method for producing a toner for developing an electrostatic charge image according to claim 2, wherein a difference (DA−DB) between the volume-average particle diameter DA of the first amorphous resin particles and the volume-average particle diameter DB of the second amorphous resin particles is 20 nm or more.

6. The method for producing a toner for developing an electrostatic charge image according to claim 3, wherein a difference (DA−DB) between the volume-average particle diameter DA of the first amorphous resin particles and the volume-average particle diameter DB of the second amorphous resin particles is 20 nm or more.

7. The method for producing a toner for developing an electrostatic charge image according to claim 4, wherein the difference (DA−DB) between the volume-average particle diameter DA of the first amorphous resin particles and the volume-average particle diameter DB of the second amorphous resin particles is 20 nm or more and 300 nm or less.

8. The method for producing a toner for developing an electrostatic charge image according to claim 5, wherein the difference (DA−DB) between the volume-average particle diameter DA of the first amorphous resin particles and the volume-average particle diameter DB of the second amorphous resin particles is 20 nm or more and 300 nm or less.

9. The method for producing a toner for developing an electrostatic charge image according to claim 6, wherein the difference (DA−DB) between the volume-average particle diameter DA of the first amorphous resin particles and the volume-average particle diameter DB of the second amorphous resin particles is 20 nm or more and 300 nm or less.

10. The method for producing a toner for developing an electrostatic charge image according to claim 1, wherein the volume-average particle diameter DA of the first amorphous resin particles is 100 nm or more and 300 nm or less, and the volume-average particle diameter DB of the second amorphous resin particles is 20 nm or more and 170 nm or less.

11. The method for producing a toner for developing an electrostatic charge image according to claim 2, wherein the volume-average particle diameter DA of the first amorphous resin particles is 100 nm or more and 300 nm or less, and the volume-average particle diameter DB of the second amorphous resin particles is 20 nm or more and 170 nm or less.

12. The method for producing a toner for developing an electrostatic charge image according to claim 3, wherein the volume-average particle diameter DA of the first amorphous resin particles is 100 nm or more and 300 nm or less, and the volume-average particle diameter DB of the second amorphous resin particles is 20 nm or more and 170 nm or less.

13. The method for producing a toner for developing an electrostatic charge image according to claim 4, wherein the volume-average particle diameter DA of the first amorphous resin particles is 100 nm or more and 300 nm or less, and the volume-average particle diameter DB of the second amorphous resin particles is 20 nm or more and 170 nm or less.

14. The method for producing a toner for developing an electrostatic charge image according to claim 5, wherein the volume-average particle diameter DA of the first amorphous resin particles is 100 nm or more and 300 nm or less, and the volume-average particle diameter DB of the second amorphous resin particles is 20 nm or more and 170 nm or less.

15. The method for producing a toner for developing an electrostatic charge image according to claim 6, wherein the volume-average particle diameter DA of the first amorphous resin particles is 100 nm or more and 300 nm or less, and the volume-average particle diameter DB of the second amorphous resin particles is 20 nm or more and 170 nm or less.

16. The method for producing a toner for developing an electrostatic charge image according to claim 7, wherein the volume-average particle diameter DA of the first amorphous resin particles is 100 nm or more and 300 nm or less, and the volume-average particle diameter DB of the second amorphous resin particles is 20 nm or more and 170 nm or less.

17. The method for producing a toner for developing an electrostatic charge image according to claim 8, wherein the volume-average particle diameter DA of the first amorphous resin particles is 100 nm or more and 300 nm or less, and the volume-average particle diameter DB of the second amorphous resin particles is 20 nm or more and 170 nm or less.

18. The method for producing a toner for developing an electrostatic charge image according to claim 10, wherein the second amorphous resin particles contain two or more amorphous resin particles having different volume-average particle diameters, and
mixed particles prepared by mixing the two or more amorphous resin particles having different volume-average particle diameters have a volume-average particle diameter in the range of the volume-average particle diameter DB of the second amorphous resin particles of 20 nm or more and 170 nm or less.

19. The method for producing a toner for developing an electrostatic charge image according to claim 1, wherein, in a particle size distribution of the second amorphous resin particles, particles having a particle diameter of 100 nm or less account for 10 vol% or more and 100 vol% or less.

20. A toner for developing an electrostatic charge image, the toner comprising toner particles obtained by the method for producing a toner for developing an electrostatic charge image according to claim 1.
